(19) United States
(12) Patent Application Publication
(10) Pub. No.: US 2026/0181613 A1
(43) Pub. Date: Jun. 25, 2026

(54) METHODS, ARCHITECTURES, APPARATUSES AND SYSTEMS FOR WTRU AGGREGATION OF NON-CONTIGUOUS COMPONENT CARRIERS

(71) Applicant: InterDigital Patent Holdings, Inc., Wilmington, DE (US)

(72) Inventors: Tao Deng, New York, NY (US); Moon IL Lee, Melville, NY (US); Paul Marinier, Brossard (CA); Virgil Comsa, Montreal (CA); Ghyslain Pelletier, Montreal (CA); Aata El Hamss, Laval (CA)

(21) Appl. No.: 18/990,922

(22) Filed: Dec. 20, 2024

(51) Int. Cl. H04W 72/0453; H04L 5/00; H04W 24/10

(52) U.S. Cl. CPC H04W 72/0453; H04L 5/001; H04W 24/10

(57) ABSTRACT

Procedures, methods, architectures, apparatuses, systems, devices, and computer program products that enable a wireless transmit/receive unit, such as user equipment, to use a single aggregated bandwidth configuration for receiving signals on a first component carrier, a second component carrier, and the frequency gap between the first and second component carriers. The WTRU may measure a parameter associated with the frequency gap, and if the measured parameter satisfies a trigger condition, the WTRU may transmit an indication of the trigger condition or the parameter to the wireless network. In response to such a trigger condition, the WTRU may continue to use the single aggregated bandwidth configuration without change, may mute resources of the first and/or the second component carriers adjacent the frequency gap, and/or may switch to another configuration in which signals on the first component carrier are received separately from signals on the second component carrier.

### TECHNICAL FIELD

The present disclosure is generally directed to the fields of communications, software and encoding, including, for example, to methods, architectures, apparatuses, systems related to receiving and processing signals on non-contiguous component carriers separated by frequency gaps.

### BACKGROUND

Contiguous spectrum allocation is often not available because in many regions the same radio frequency band is allocated to different operators and thus the frequency band is sometimes fragmented. The radio spectrum allocated to different operators can be used for the same or for different Radio Access Technologies (RAT). A frequency gap between component carriers (CCs) may thus arise (e.g., in fifth generation new radio (5G NR)), and transmissions in the frequency gap may cause interference.

### SUMMARY OF THE DISCLOSURE

Described are methods, systems, architectures, apparatuses, non-transitory computer-readable media, and means for performing such methods that enable a wireless transmit/receive unit (WTRU) to be in communication with a wireless network, such as a base station, with the WRTU using two component carriers separated by a frequency gap, for example, a frequency gap that is allocated to a different operator or that is used for unrelated communication. Various types of user equipment (UE) may comprise or serve as WTRUs.

In some such methods, the WTRU may use a single aggregated bandwidth configuration to receive signals on the first component carrier, the second component carrier, and the frequency gap between the first and second component carriers. The WTRU may measure a parameter associated with the frequency gap, and based on the measured parameter satisfying a trigger condition, the WTRU may transmit an indication of the trigger condition or the parameter to the wireless network. some embodiments, in response to such a transmission to the wireless network, the wireless network may request or instruct the WTRU to continue to use the single aggregated bandwidth configuration without change, may request or instruct the WTRU to continue to use the single aggregated bandwidth configuration but mute resources of the first and/or the second component carrier(s) adjacent the frequency gap, may request or instruct the WTRU to continue to use the single aggregated bandwidth configuration and increase or decrease the extent of muted resources of the first and/or the second component carrier adjacent the frequency gap.

In certain representative embodiments, the wireless network may request or instruct the WTRU to use a separate bandwidth configuration to separately receive signals within a channel bandwidth of the first component carrier and a channel bandwidth of the second component carrier, such that a frequency gap exists between the first and second component carriers which is not received. In certain representative embodiments, the wireless network may request or instruct the WTRU to use some other configuration, including, for example, one of the configurations described herein.

In certain representative embodiments, in response to the measured parameter satisfying the trigger condition, the WTRU may take one or more of the above-described actions (e.g., mute resources, switch configurations, or a combination of the foregoing) without instruction or request from the wireless network. In such a method, based on the measured parameter satisfying the trigger condition, a separate bandwidth configuration may be activated to separately receive signals on a channel bandwidth of each of the first and second component carriers.

The parameter may be, or may include, for example, one or more signal strength indicators (e.g., RSSI) of the frequency gap. The parameter may be, or may include, for example, a determination of signal strength of the component carriers relative to signal strength of the frequency gap. The determined muted resources may then be determined based on a mapping between signal strength indicators and resources to be muted. In addition, a resource grid of the first and second component carriers may be updated based on the determined muted resources. This may be a dynamic update in real time.

In certain representative embodiments, before the single aggregated bandwidth configuration is used, the WTRU may use a separate bandwidth configuration to receive signals on the channel bandwidth of the first component carrier separately from the channel bandwidth of the second component carrier. For example, a first front end may be used for the first component carrier and a second front end may be used for the second component carrier. In some embodiments, the first component carrier and the second component carrier may be a joint component carrier.

In certain representative embodiments, a method may be performed by the WTRU in communication with a wireless network, in which the WTRU uses a separate bandwidth configuration to separately receive signals on a channel bandwidth of a first component carrier and a channel bandwidth of a second component carrier, wherein a frequency gap exists between the first and second component carriers. A parameter associated with the frequency gap may be measured and, based on the measured parameter satisfying a switch condition, a single aggregated bandwidth configuration may be activated. Such a single aggregated bandwidth configuration may receive signals on the first component carrier, the second component carrier, and the frequency gap.

In certain representative embodiments, the parameter associated with the frequency gap or the satisfying of the switch condition may be reported to the wireless network, and the wireless network may instruct or request the WTRU to switch to the single aggregated bandwidth configuration. In certain representative embodiments, based on the parameter associated with the frequency gap or the satisfying of the switch condition, the WTRU may initiate the switch to the single aggregated bandwidth configuration and may report the parameter associated with the frequency gap or the satisfying of the switch condition to the wireless network.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a fragmented spectrum due to allocation to different operators in the same frequency band, in accordance with some embodiments of this disclosure;

FIG. 3A-3C illustrate examples of CA configurations for two intra-band non-contiguous component carriers, in accordance with some embodiments of this disclosure;

FIGS. 4A-4B illustrate an example of a switch between a multi-carrier-based CA configuration with separate CC channel bandwidths and a multi-carrier-based CA configuration with a single aggregated channel bandwidth that includes two CCs and the frequency gap between them, in accordance with some embodiments of this disclosure;

FIGS. 5A-5B illustrate an example of a switch between a multi-carrier-based CA configuration with separate CC channel bandwidths and a single-carrier-based CA configuration with a single aggregated channel bandwidth, in accordance with some embodiments of this disclosure;

FIGS. 6A-6B illustrate an example of a switch between a non-CA configuration and a multi-carrier-based CA configuration with a single aggregated channel bandwidth with two component carriers separated by the frequency gap, in accordance with some embodiments of this disclosure;

FIGS. 7A-7B illustrate an example of a switch between non-CA configuration and single-carrier-based CA configuration with a single aggregated channel bandwidth with a joint component carrier, in accordance with some embodiments of this disclosure;

FIG. 8 illustrates an example of a process used by a single aggregated channel bandwidth for determining whether to take action based on a trigger condition, in accordance with some embodiments of this disclosure; and

FIG. [8] 9 illustrates an example of a process for determining whether to switch to a single aggregated channel bandwidth, in accordance with some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

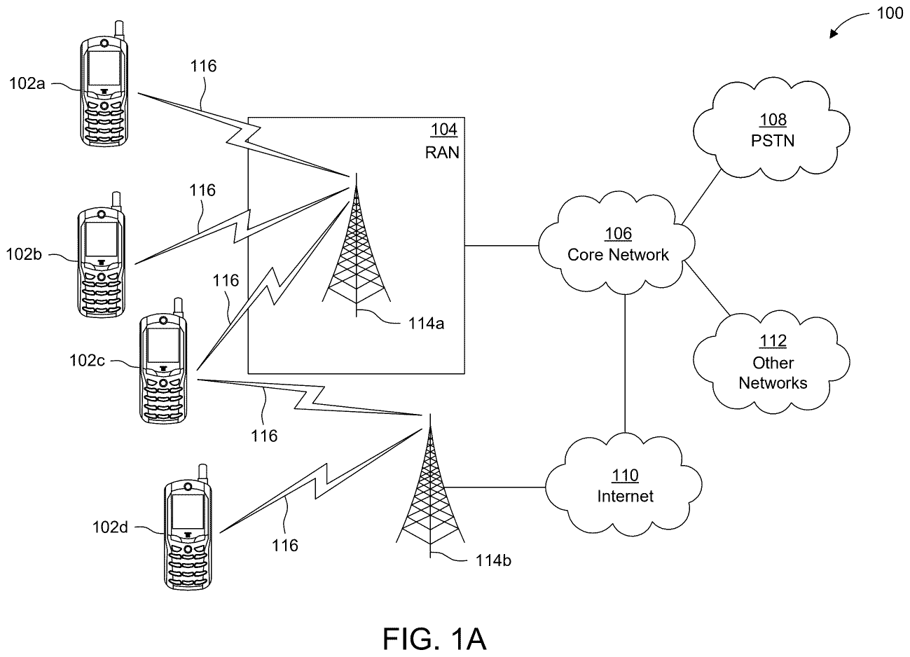

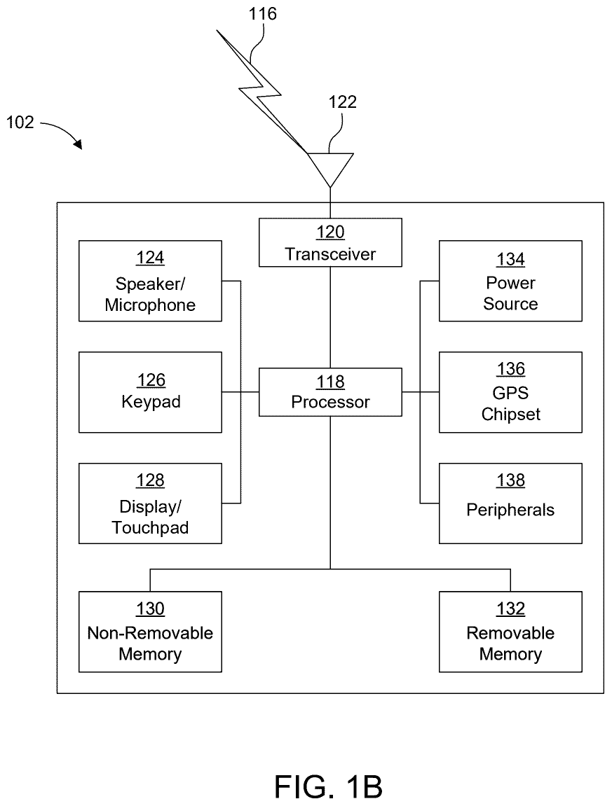

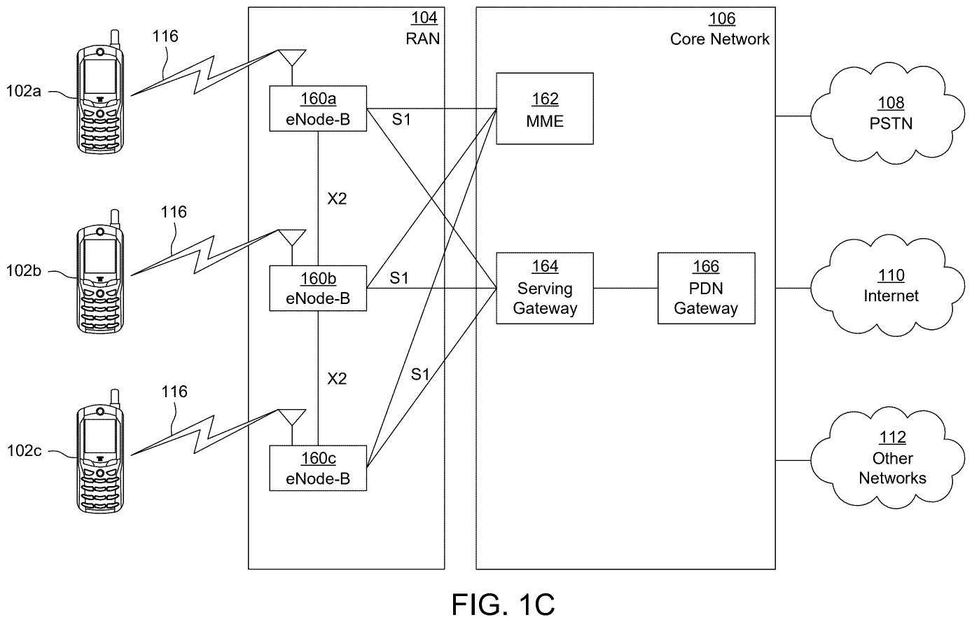

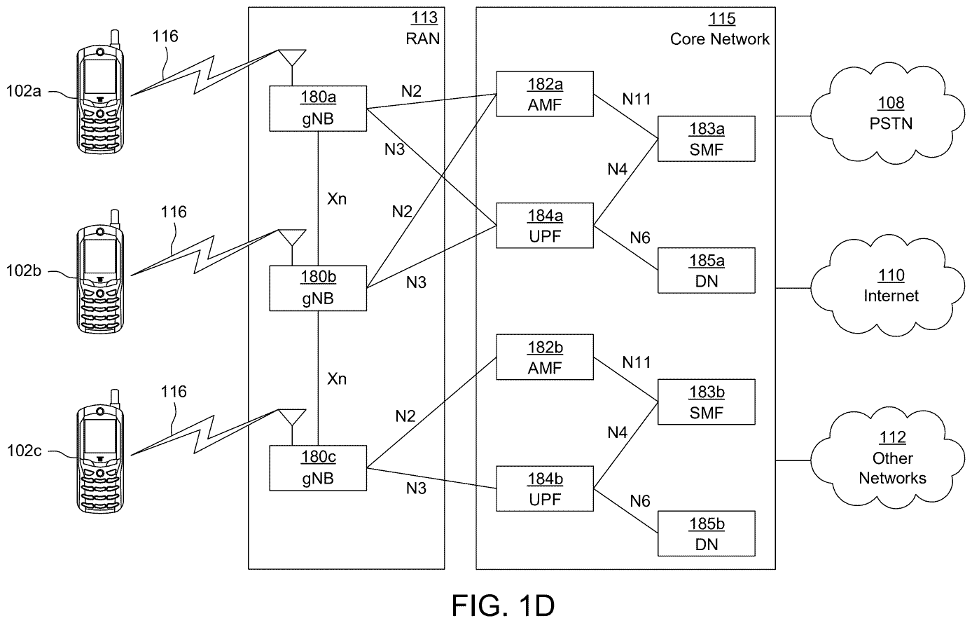

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as New Radio (NR) Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN. A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel. Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNodeBs (gNB) s 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Carrier Aggregation

In NR (new radio) carrier aggregation (CA), a WTRU may be configured with bandwidth aggregation over two or more component carriers (CC) belonging to one cell to improve capacity and/or coverage performance. Component carriers of different bandwidths in the same frequency band or different frequency bands can be aggregated.

Carrier aggregation of contiguous component carriers within the same frequency band is referred as intra-band contiguous CA. Carrier aggregation can also be done over non-contiguous component carriers in the same band, or in different bands, which is referred as intra-band non-contiguous CA or inter-band non-contiguous CA, respectively. For non-contiguous CA, two CCs are separated by a frequency gap.

A CA configuration may thus be a combination of the operating band and CA bandwidth class. A CA bandwidth class specifies a maximum aggregated bandwidth and maximum number of CCs included in the CA configuration. For both contiguous and non-contiguous CA, the aggregated bandwidth is the sum of the bandwidths of the aggregated CCs, i.e., the frequency gap bandwidth is not included in the aggregated bandwidth.

Intra-band contiguous CA is relatively easier to implement, especially from a radio frequency RF analogue hardware perspective, but requires contiguous CCs used in a cell within spectrum allocated to one operator. In this case, the aggregated bandwidth is the total of the channel bandwidth of each aggregated component carrier, i.e. a single aggregated bandwidth.

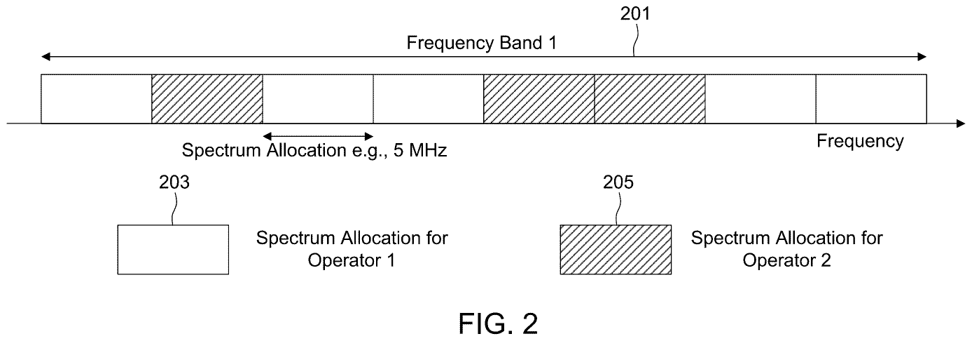

As shown in FIG. 2, a frequency band 201 may have spectrum allocations 203 for a first operator interspersed with frequency allocations 205 for a second operator. Contiguous spectrum allocation is often not implemented--in many regions and the radio spectrum is fragmented. It is common to have regional arrangements allocating spectrum in the same frequency band to different operators. Thus, non-contiguous CA has become an important tool to enable aggregation over non-contiguous CCs belonging to a cell by one operator and make efficient use of fragmented spectrum.

Moreover, the spectrum allocated to different operators may be used for the same or different Radio Access Technology (RAT). The transmissions within the frequency gap between CCs (e.g., in 5G NR non-contiguous CA) may thus be uncoordinated and cause strong interference. For example, to handle this interference, 5G NR non-contiguous CA configuration in R19 3rd Generation Partnership Project (3GPP) release is based on separate analogue reception (RX) chain for each non-contiguous carrier. RX band filtering in the first stage of the RX chain may effectively attenuate unwanted signal transmissions in the frequency gap that exists between component carriers-this may minimize interference to the reception of wanted signal of the component carriers. Therefore, the aggregated bandwidth may not be a single contiguous bandwidth, as it may be in contiguous CA implementations. Instead, a sub-block may be specified, such that each sub-block includes one or more contiguous CCs within the CA configuration. In such implementations, the aggregated channel bandwidth includes the bandwidth of all the sub-blocks. The aggregated channel bandwidth would not include the frequency gap between sub-blocks and/or CCs and is not a single contiguous frequency resource configuration.

The number of RX chains of a WTRU may thus limit the number of component carriers that the WTRU can simultaneously receive. Stated differently, the maximum supported number of component carriers for a CA combination that the WTRU simultaneously receives may be limited by the number of RX chains of the WTRU's hardware. This limitation may reduce spectrum utilization efficiency by an operator, especially, in a fragmented spectrum where the aggregated component carriers are non-contiguous.

Removing this limitation has been discussed by operators. In some approaches, a single RX chain may be used to aggregate more than one intra-band non-contiguous CCs—this may reduce the number of RX chains needed for reception by the WTRU at any one time.

According to an aspect of the disclosure, a single RX chain 404 may receive signals on a single aggregated bandwidth that includes two or more non-contiguous component carriers, e.g., CC1 and CC2, as well as the frequency gap between the (e.g., two) CCs. In this case, the frequency gap is within the RF band filtering bandwidth at the first stage of the RX front. For this reason, the transmission of unwanted signals within the frequency gap may not be attenuated and may pass through the first stage of the RX chain together with the wanted signals of the aggregated CCs. As a result, the transmission of unwanted signals in the frequency gap may subject the subsequent stages of the reception of the wanted signals to potentially strong adjacent channel interference and/or spurious emission. Moreover, when the received power spectral density of the unwanted signals is considerably higher than that of the wanted signals in the aggregated CCs, the RX front end may experience dynamic range issue—for example, the WTRU may be unable to receive the weak wanted signal immersed in the strong unwanted signal of the frequency gap.

According to an aspect of the disclosure, carrier aggregation using a single RX chain to receive signals on more than one intra-band non-contiguous carriers may be enabled with efficient handling of in-channel interference from frequency gap transmissions.

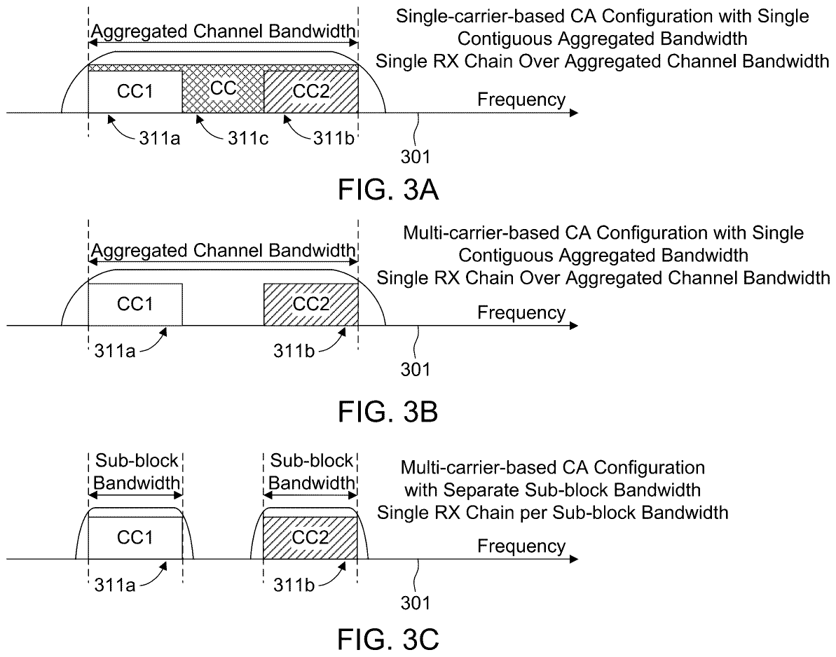

In certain representative embodiments, a WTRU may be configured or preconfigured with one or more carrier aggregation (CA) configurations so that the WTRU aggregates two or more intra-band non-contiguous component carriers. The CA configurations may include at least the following configurations: single-carrier-based configuration with single aggregated channel bandwidth, as shown in FIG. 3A; multi-carrier-based CA configuration with single aggregated channel bandwidth over the frequency spectrum 301, as shown in FIG. 3B; and multi-carrier-based CA configuration with separate sub-block bandwidth, as shown in FIG. 3C.

FIG. 3A illustrates an example of a single-carrier-based CA configuration with single aggregated channel bandwidth 311c. A WTRU may be (pre) configured with a single joint component carrier in a single-carrier-based CA configuration. A WTRU may be (pre) configured with a single primary and/or special cell for the joint component carrier. A WTRU may be (pre) configured with a single aggregated bandwidth over a contiguous spectrum allocation as the channel bandwidth of the joint component carrier.

For an aggregation of two intra-band non-contiguous component carriers CC1 311a and CC2 311b with a frequency gap in-between, a WTRU may be (pre) configured with a single joint component carrier (CC) including radio resources of CC1 and CC2. A WTRU may be (pre) configured with radio resource control and management information specific to the joint CC, e.g., radio resource control (RRC) configuration of the joint CC.

The aggregated channel bandwidth, i.e. the channel bandwidth of the joint CC may include the channel bandwidth of both CC1 and CC2 and the intermediate frequency gap. The aggregated channel bandwidth may thus be a contiguous spectrum allocation from the lower edge of the lower CC (i.e. CC1) to the higher edge of the upper CC (i.e. CC2). The CA configuration may thus include a center frequency and size (e.g. number of RBs) of the single aggregated channel bandwidth. Also, the CA configuration may include the size of the component carrier gap (e.g. number of RBs). A WTRU may be (pre) configured with one or more bandwidth parts (BWPs) within the channel bandwidth of the joint CC and thus one or more BWPs may include partial or entire frequency gap between CC1 and CC2.

FIG. 3B illustrates an example of multi-carrier-based CA configuration with single aggregated channel bandwidth. A WTRU be (pre) configured with a single aggregated channel bandwidth over a contiguous spectrum allocation. The number of (pre) configured cells may be the same as the number of aggregated component carriers. A WTRU may be (pre) configured with a primary and/or special cell in one aggregated component carrier and a secondary and/or special cell in another aggregate component carrier.

FIG. 3B illustrates an example of an aggregation of two intra-band non-contiguous component carriers CC1 and CC2 with a frequency gap in-between. A WTRU may be (pre) configured with two aggregated component carriers, i.e. CC1 and CC2. A WTRU may be (pre) configured with radio resource control and management information specific to CC1 and CC2, i.e. separate RRC configuration for CC1 and CC2. The aggregated channel bandwidth, i.e. the bandwidth of the aggregated CC may include the channel bandwidth of both CC1 and CC2 and the intermediate frequency gap. The aggregated channel bandwidth may thus be a contiguous spectrum allocation from the lower edge of the lower CC (i.e. CC1) to the higher edge of the upper CC (i.e. CC2). The CA configuration may thus include a center frequency and size (e.g. number of RBs) of the single aggregated channel bandwidth. A WTRU may be (pre) configured with one or more bandwidth parts (BWPs) within the channel bandwidth of CC1 and/or CC2. A WTRU may not be (pre) configured with any BWP that may include partial or entire frequency gap between CC1 and CC2.

FIG. 3C illustrates an example of a multi-carrier-based CA configuration with separate sub-block channel bandwidth. In a multi-carrier-based CA configuration, a WTRU be (pre) configured with separate and multiple sub-block channel bandwidths. Each sub-block may include one or more contiguous CCs. Each sub-block may include one or more contiguous CC(s). The number of (pre) configured cells may be the same as the number of aggregated sub-blocks. A WTRU may be (pre) configured with a primary and/or special cell in one sub-block and a secondary and/or special cell in another sub-block. A WTRU may not be (pre) configured with a single aggregated channel bandwidth.

For an aggregation of two intra-band non-contiguous component carriers CC1 and CC2 with a frequency gap in-between, as shown in the example illustrated in FIG. 3C, a WTRU may be (pre) configured with two aggregated component carriers, i.e. CC1 and CC2. A WTRU may be (pre) configured with radio resource control and management information specific to CC1 and CC2, i.e. separate RRC configuration for CC1 and CC2. The aggregated channel bandwidth may include separate sub-block channel bandwidths, such that the first sub-block may include CC1 and the second sub-block may include CC2. The aggregated channel bandwidth may thus not include the frequency gap between CC1 and CC2. A WTRU may be (pre) configured with one or more bandwidth parts (BWPs) within the channel bandwidth of CC1 and/or CC2. A WTRU may not be (pre) configured with any BWP that may include partial or entire frequency gap between CC1 and CC2.

When the WTRU is set up to support CA configurations with single aggregated channel bandwidth, the WTRU may use a single RX chain 403a to receive signals on a first aggregated component carrier and/or sub-block and may use a single RX chain 403b to receive signals on a second aggregated component carrier and/or sub-block for a multi-carrier-based CA configuration with separate sub-block bandwidth. A WTRU may operate within the sub-block and/or CC channel bandwidth for each used RX chain. In one example, a WTRU may report the capability of using a RX chain per aggregated component carrier in a multi-carrier-based CA configuration with separate sub-block bandwidth as a default capability. A WTRU may accordingly be (pre) configured with multi-carrier-based CA configuration with separate sub-block bandwidth as a default and/or fallback CA configuration for CA over intra-band non-contiguous component carriers.

A WTRU may support using a single receiver chain to receive signals on a joint component carrier and/or all aggregated component carriers within a single aggregated channel bandwidth. A WTRU may operate within single aggregated channel bandwidth using the single RX chain and therefore may be required to have a capability of suppressing the interference caused by the transmissions of unwanted signals present in the frequency gap aggregated channel bandwidth. In one example, this capability may be enabled by WTRU interference filtering and/or cancellation techniques, e.g., sub-band analogue filtering.

A WTRU may thus report to the wireless network its capability of using single RX chain for a single aggregated channel bandwidth that includes the frequency gap. In another example, a WTRU may report capability of support for non-contiguous CA configurations with single aggregated channel bandwidth, e.g., for single-carrier-based and multi-carrier-based CA configuration with single aggregated bandwidth. In a further example, a WTRU report a capability of support for CA with more than one sub-block.

In another example, a WTRU may be (pre) configured with a set of non-contiguous CA aggregated channel bandwidth classes. An aggregated bandwidth class may indicate the aggregated channel bandwidth configuration, e.g., support of single aggregated bandwidth using one RX chain for CA configuration. A WTRU may report a capability of the supported CA bandwidth classes.

In a further example, a WTRU may be (pre) configured to include capability metrics and/or conditions in the support for non-contiguous CA configurations with single aggregated channel bandwidth. The metrics and/or conditions may include one or more of the following: maximum supported number of frequency gaps within a single aggregated bandwidth; maximum received power spectral density allowed within the frequency gap (e.g., in unit of dBm/MHz); maximum received power spectral density imbalance/difference allowed between aggregated component carriers within a single aggregated bandwidth (e.g., in unit of dB); maximum received power spectral density imbalance/difference allowed between received power spectral density allowed within the frequency gap and one or more aggregated component carriers in the single aggregated bandwidth (e.g. in unit of dB); number of aggregated component carriers; number of RX chains used for carrier aggregation.

WTRU reporting of the above-discussed capability may provide the network with information for selecting CA configurations for the reporting WTRU. A WTRU may report such capability using RRC signaling and/or UL Assistance Information (UAI). Based on the reported WTRU capability, a WTRU may be set to a configuration for aggregation of two or more same intra-band non-contiguous component carriers. For example, when a WTRU reports to the wireless network its capability to support intra-band non-contiguous CA configuration with single aggregated channel bandwidth, the WTRU may be set to one of the following configurations for aggregation of two or more intra-band non-contiguous component carriers: a single-carrier-based CA configuration with a single aggregated channel bandwidth; or, a multi-carrier-based CA configuration with a single aggregated channel bandwidth; multi-carrier-based CA configuration with separate sub-block bandwidths.

In certain representative embodiments, the WTRU may be (pre) configured with a multi-carrier-based CA configuration with separate sub-block bandwidths as a default and/or fallback configuration. When a WTRU may not or cannot perform CA, a WTRU may be (pre) configured with an RRC configuration associated with a non-CA configuration.

A WTRU may be (pre) configured with an identity for each CA configuration in the CA configuration set. In one solution, an ID may be assigned to each CA configurations in a RRC configuration when a WTRU may be (pre) configured to perform a carrier aggregation over intra-band non-contiguous CCs. For example, the CA configuration ID for the default and/or fallback CA configuration may be zero. The CA configuration ID for multi-carrier-based CA configuration with single aggregated channel bandwidth and single-carrier-based CA configuration with single aggregated channel bandwidth may be one and two, respectively.

When a WTRU is (pre) configured with the abovementioned CA configuration, the WTRU may receive one or more RRC configuration(s) associated with each CA configuration. In one example, a WTRU may receive a RRC configuration associated with each aggregated component carrier for the multi-carrier-based CA configurations and a RRC configuration associated with the joint component carrier for the single-carrier-based CA configurations. A RRC configuration may include e.g., downlink/uplink (DL/UL) time division duplexing (TDD) configuration, DL and/or UL bandwidth part (BWP) configuration, measurement configuration, control and data channel configuration, data channel configuration for both DL and UL, reference signal configuration, beam failure recovery configuration, radio link monitoring configuration, etc.

A WTRU may change one CA configuration to another CA configuration, i.e., the WTRU may undergo a CA configuration switch. A WTRU may (pre) configured with the following CA configurations in accordance with the reported WTRU capability, introduced above: Single-carrier-based CA configuration with a single aggregated channel bandwidth; a multi-carrier-based CA configuration with a single aggregated channel bandwidth; or a multi-carrier-based CA configuration with separate sub-block bandwidths.

In addition, a WTRU may switch between a non-CA configuration and a single- or multi-carrier-based CA configuration with a single aggregated channel bandwidth. Thus, the WTRU may use a single RX chain.

A WTRU may perform measurements using the single aggregated channel bandwidth with a single RX chain. Such a single aggregated channel bandwidth measurement may include one or more of the following: RSSI of the frequency gap included in the single aggregated channel bandwidth, e.g., frequency gap RSSI. In one example, a WTRU may be (pre) configured with a bandwidth part (BWP), e.g., a frequency gap BWP as the measurement bandwidth of the frequency gap RSSI. In another example, a WTRU may be communicated by the wireless network regarding the size of the frequency gap and the size of (pre) configured fixed guard band allocation 413a, 413b on either side of the frequency gap. The size may be indicated to the WTRU in terms of the number of RBs/sub-carriers or in terms of kHz/MHz. The WTRU may determine a measurement bandwidth for the frequency gap RSSI by subtracting the frequency gap bandwidth with the guard band allocation 413a, 413b.

RSSI of joint component carrier over the single aggregated channel bandwidth, e.g., joint component carrier RSSI. In one example, a WTRU may be (pre) configured to perform a joint component carrier RSSI measurement over a measurement bandwidth based on a (pre) configured measurement BWP including the channel bandwidth of the aggregated component carriers and the frequency gap.

RSSI of each aggregated component carrier, e.g., aggregated component carrier RSSI may be measured. In one example, a WTRU may measure component carrier RSSI of an aggregated component carrier over a measurement bandwidth based on a (pre) configured measurement BWP including the channel bandwidth of the aggregated component carrier.

Various parameters may be used to determine whether further action, such as reporting to the wireless communication, additional guard muting, or a switch to another configuration is warranted, including, for example, one or more of RSSI and/or signal to interference and/or noise ratio (SINR) and/or received signal strength indicator (RSRQ) and/or intermodulation (IM) of the RS resources configured within aggregated component carrier, e.g., channel state information (CSI)-RSSI/CSI-RSRQ/CSI-SINR, SS-RSSI/SS-RSRQ/SS-SINR, CSI-IM and RSSI of the transmissions within the frequency gap measured over the RS resources. A WTRU may be (pre) configured to measure RSSI/RSRQ/SINR of the CSI-RS transmissions configured over a measurement bandwidth configured in aggregated component carriers. A WTRU may be (pre) configured with ZP-CSI-RS resources for IM measurement. In addition, RSSI/RSRQ/SINR/IM/CQI of a (pre) configured number of resources, RBs/RBGs at the edge of aggregated component carrier and adjacent to the frequency gap, e.g., CSI-RSSI/CSI-RSRQ/CSI-SINR, SS-RSSI/SS-RSRQ/SS-SINR, CSI-IM and RSSI of the transmissions within the frequency gap measured over the (pre) configured resources may be used. A WTRU may be (pre) configured with measurement bandwidth based the (pre) configured resources, e.g. RBs/RBGs adjacent to the frequency gap, i.e. at the edge of each aggregated component carrier next to the frequency gap.

In another solution, a WTRU may perform (pre) configured measurements related to separate sub-block channel bandwidth using a single RX chain for each aggregated sub-block and/or component carrier. Such (pre) configured separate sub-block channel bandwidth measurement may include one or more of the following:

By way of a first example, RSSI of each aggregated component carrier, e.g., aggregated component carrier RSSI. In one example, a WTRU may be (pre) configured to measure component carrier RSSI of an aggregated component carrier over a measurement bandwidth based on a (pre) configured measurement BWP including the channel bandwidth of the aggregated sub-block and/or component carrier.

According to another example, RSSI/RSRQ/SINR/IM of the RS resources configured within aggregated component carrier, e.g., CSI-RSSI/CSI-RSRQ/CSI-SINR, SS-RSSI/SS-RSRQ/SS-SINR and CSI-IM. A WTRU may be (pre) configured to measure RSSI/RSRQ/SINR of the CSI-RS transmissions configured over a measurement bandwidth configured in aggregated component carriers. A WTRU may be (pre) configured with ZP-CSI-RS resources for IM measurement. In certain representative embodiments, one or more of such parameters may be communicated by the wireless network to the WTRU.

In certain representative embodiments, a WTRU may perform one or more of above-mentioned single aggregated channel bandwidth measurements within a (pre) configured measurement window. A WTRU may be (pre) configured with one or more of the following parameters of the measurement window: A WTRU may re-tune the center frequency according to the measurement bandwidth of the performed measurement in the beginning and end of the measurement window. The duration of the measurement window may thus include the time for the frequency re-tuning and the symbols for the measurement. A WTRU may not expect data transmission during the duration of the measurement window.

In one example, a WTRU may be indicated to perform a periodical measurement according to the periodicity of the measurement window.

In one example, a WTRU may be indicated/activated to perform a measurement in each of the (pre) configured consecutive measurement window. A WTRU may (pre) configured with a time interval between consecutive measurement windows.

A WTRU may perform the measurement over the (pre) configured symbols, in an implementation. The symbols may be located in the middle of the measurement window. In one example, the symbols may be synchronization signal block (SSB) or CSI-RS symbols (pre) configured for the aggregated component carriers for SS-RSSI/RSRQ/SINR or CSI-RSSI/RSRQ/SINR measurement, respectively.

In certain representative embodiments, a WTRU may determine a receive spatial filter configuration (i.e., RX beam) as a measurement spatial filter configuration single aggregated channel bandwidth measurements, for example, as follows:

By way of an example, the WTRU may determine to use the same receive spatial filter configuration as the one used to receive a SSB transmission of an aggregated component carrier for frequency gap RSSI measurement, joint component carrier RSSI measurement, aggregated component carrier RSSI, SS-RSSI/RSRQ/SINR measurement and/or CSI-IM measurement. In one example, the SSB transmission may be a Cell-Defining SSB (CD-SSB) or a Non-Cell-Defining SSB (NCD-SSB) of the aggregated component carrier that may be a parameterized cell (PCell) and/or a special cell (SpCell) in the multi-carrier-based CA configuration. In another example, the SSB transmission may be a Non-Cell-Defining SSB (NCD-SSB) of the aggregated component carrier that may be a secondary cell (SCell) and/or SpCell in the multi-carrier-based CA configuration.

The WTRU may determine to use a receive spatial filter configuration associated with omni-directional reception, for example, an omni-directional RX beam for frequency gap RSSI measurement, joint component carrier RSSI measurement, aggregated component carrier RSSI and/or CSI-IM measurement.

The WTRU may determine to use a set of different receive spatial filter configurations with each configuration used to receive a (pre) configured SSB transmissions on an aggregated component carrier that may be a primary cell (PCell), SCell and/or SpCell in the multi-carrier-based CA configuration. A WTRU may apply the set of different receive spatial filter configurations for frequency gap RSSI measurement and/or joint component carrier RSSI measurement. For example, a WTRU may use a different receive spatial filter configuration in each of the consecutive symbols (i.e. sweep of RX beams) (pre) configured for measurement within the measurement window.

The WTRU may determine to use a receive spatial filter configuration corresponding to the transmission configuration indicator (TCI) state of a CSI-RS transmission (pre) configured for a CSI-RSSI/RSRQ/SINR measurement.

In certain representative embodiments, a WTRU may determine an interference level associated with a measurement spatial filter configuration used in the single aggregated channel bandwidth measurement. A WTRU may further associate such an interference level with the reception of the SSB and/or CSI-RS transmission corresponding to the used measurement spatial filter configuration. In one example, when a WTRU may measure a frequency gap RSSI using a measurement spatial filter configuration identical to a receive spatial filter configuration used for a CD-SSB reception of an aggregated component carrier, a WTRU may associate the measured RSSI with the reception of the CD-SSB, i.e., an interference to the CD-SSB reception from transmissions within the frequency gap.

In certain representative embodiments, a WTRU may evaluate the results of WTRU measurements for single aggregated channel bandwidth based on one or more (pre) configured evaluation process. A WTRU may apply an evaluation process for the measurement using identical receive spatial filter configuration. For example, a WTRU may apply a filtering of the RSSI, RSRQ, SINR and/or IM results measured from each measurement window using identical receive spatial filter configuration. In certain representative embodiments, the WTRU may be (pre) configured with filtering coefficients and a sliding window. Thus, the WTRU may weight each measurement result within the sliding window with the filtering coefficient to obtain a filtered measurement result.

In another example, a WTRU may average the RSSI, RSRQ, SINR and/or IM results measured using identical receive spatial filter configuration within a measurement window. In addition, a WTRU may average such measurement results over a (pre) configured number of measurement windows.

In certain representative embodiments, a WTRU may determine an incremental metric for a (pre) configured counter based on the RSSI, RSRQ, SINR and/or IM measurement result from a measurement window and a threshold. For example, when a measured result from a measurement window may be above or below a threshold, a WTRU may determine a positive incremental metric and thus increase the count by one. When a measured result may be below or above the threshold, a WTRU may determine a negative incremental metric and thus decrease the corresponding counter by one. Alternatively, a WTRU may start a timer when a WTRU may increase the counter. A WTRU may re-start the timer when a WTRU may increase the counter again. When the timer may expire, a WTRU may reset the value of the counter to zero.

In an embodiment, a WTRU may adjust the measurement results based on information pertaining to the transmissions within the frequency gap. For example, a WTRU may be indicated with transmission ON/OFF schedule information. Such information may include the timer periods in which the transmissions within the frequency gap may be turned off. The RAT operating within the frequency gap in the single aggregated channel bandwidth may be 5G NR by another operator and the cell may be (pre) configured with a Network Energy Saving (NES) state in which the cell transmission may be turned on and off according to a TX ON/OFF schedule. In an implementation, cellular operators may exchange the NES cell ON/OFF information so that the information may be available for a WTRU performing measurements for the CA configuration. For example, a WTRU may remove a measurement result from a measurement window overlapping with one or more indicated Cell OFF period so the evaluated measurement result (e.g., based on abovementioned filtering, averaging or counting) may not be biased by measurement done during the cell OFF periods.

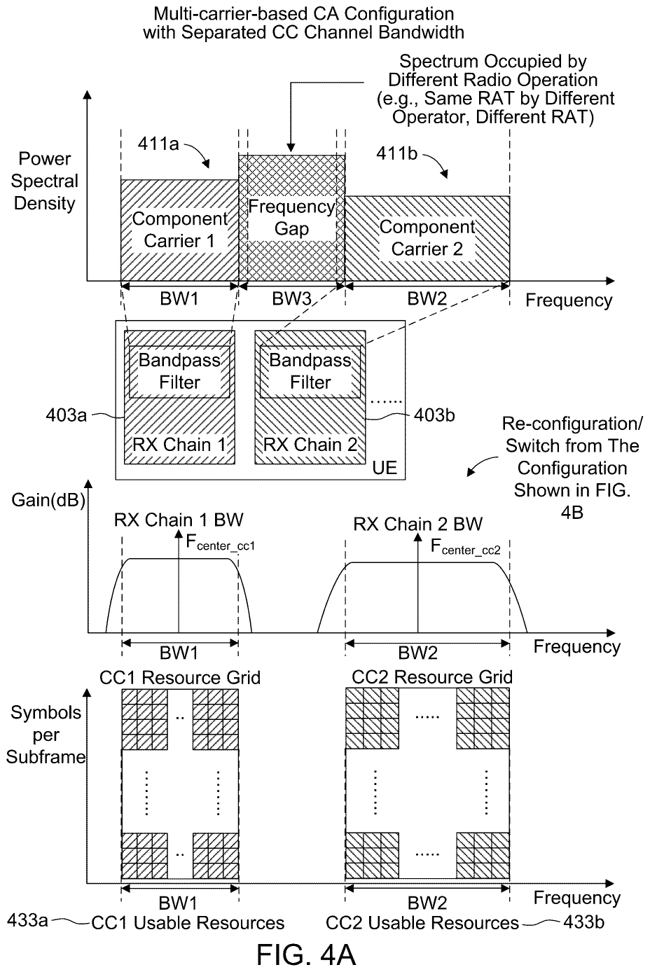

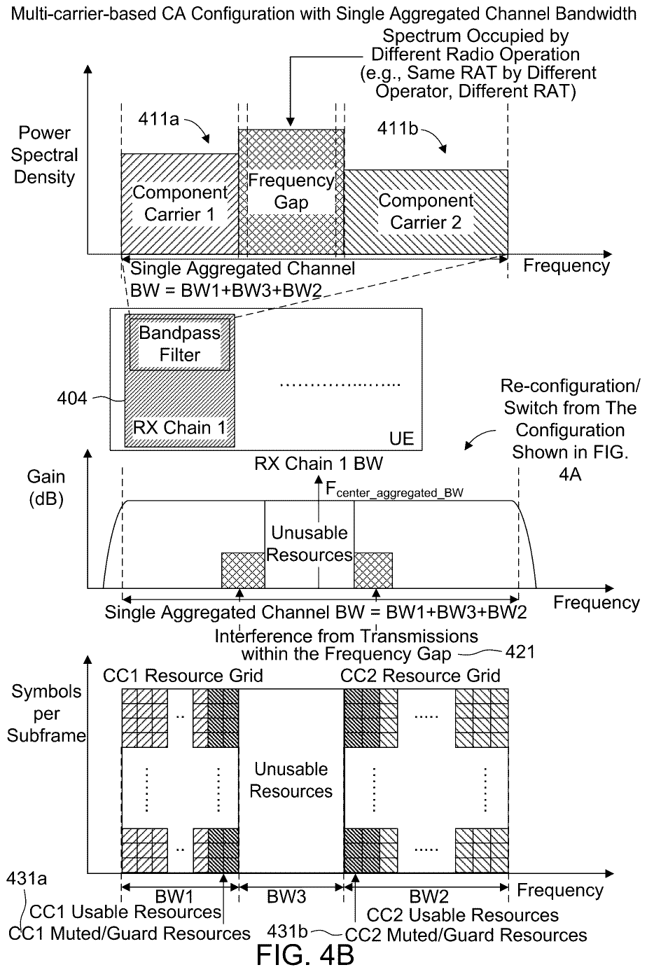

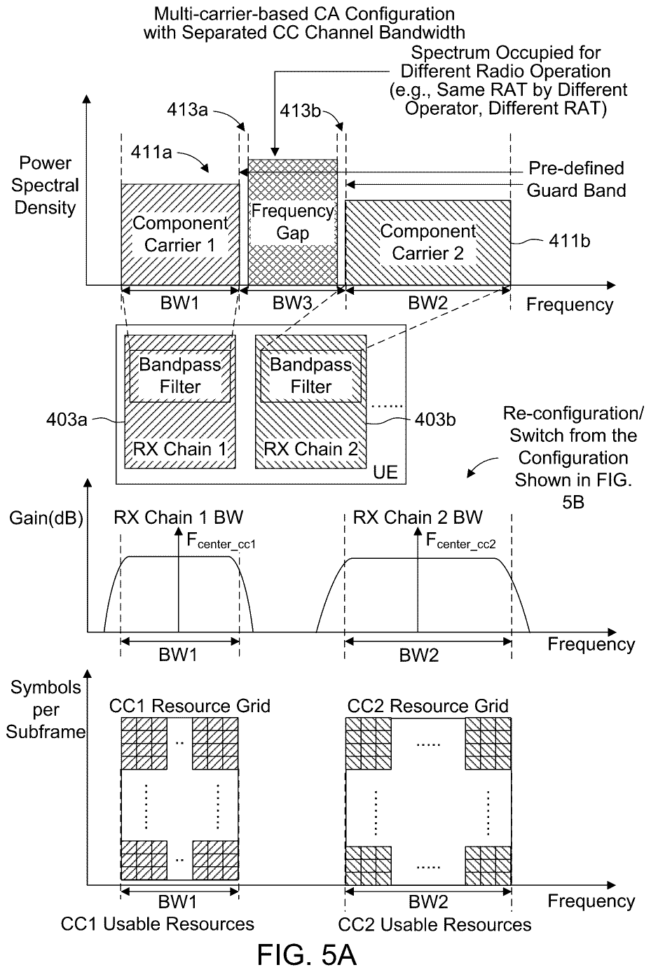

A WTRU may initiate carrier aggregation with a default/fallback CA configuration when it may be indicated by the network to perform CA over two intra-band non-contiguous component carriers with one of the CC being the serving cell. A WTRU may switch between a multi-carrier-based CA configuration with separate sub-block bandwidth and multi-carrier-based CA configuration with single aggregated channel bandwidth as indicated in FIGS. 4A-4B.

As shown in FIGS. 4A-4B, a WTRU may be pre-configured with two carrier aggregation configurations for two intra-band non-contiguous component carriers. The first configuration, an example of which is shown in FIG. 4A, may be based on a non-contiguous aggregated bandwidth combination including the channel bandwidth of each component carriers (CC1 and CC2). Thus, the center frequency, channel bandwidth, and guard band, may be determined for each component carrier separately (as shown, for example, in FIG. 4A). This may be the default/fallback configuration for the device. RX chain gain and usable resources are shown, respectively, in graphs 403 and 405 for FIG. 4A and in graphs 404 and 406 for FIG. 4B.

As shown in FIG. 4A, signals on component carrier 1 in BW1 are received by RX chain 1 of the WTRU in a multi-carrier based CA configuration with separate CC channel bandwidth 401. RX chain 1 includes a bandpass filter for receiving BW1. Signals on component carrier 2 in BW2 are received by RX chain 2 of the WTRU. RX chain 2 includes a bandpass filter for receiving signals on BW2. Usable resources received by RX chain 1 are shown near the bottom of FIG. 4A as CC1 usable resources. Usable resources received by RX chain2 are shown near the bottom of FIG. 4A as CC2 usable resources.

The second configuration, an example of which is shown in FIG. 4B, may be based a multi-carrier based CA configuration with single aggregated channel bandwidth 402 that includes the channel bandwidth of each component carrier (CC1 and CC2) and the frequency gap (CC gap) in-between the two component carriers (as shown, for example, in FIG. 4B). The center frequency and size of the aggregated bandwidth may thus be determined for this aggregated bandwidth.

FIG. 4B illustrates a single RX chain of the WTRU receiving signals on component carrier 1 (BW1), component carrier 2 (BW2), and the frequency gap (BW3) between the two component carriers. The bandpass filter of single RX chain 1 of the WTRU receives signals on BW1, BW2 and BW3. In the example illustrated in FIG. 4B, due to interference from the frequency gap transmissions in BW3, some of the resources of component carriers 1 and 2 adjacent the frequency gap are unusable. For this reason, some of the resources of each of component carriers 1 and 2 adjacent the frequency gap may be muted.

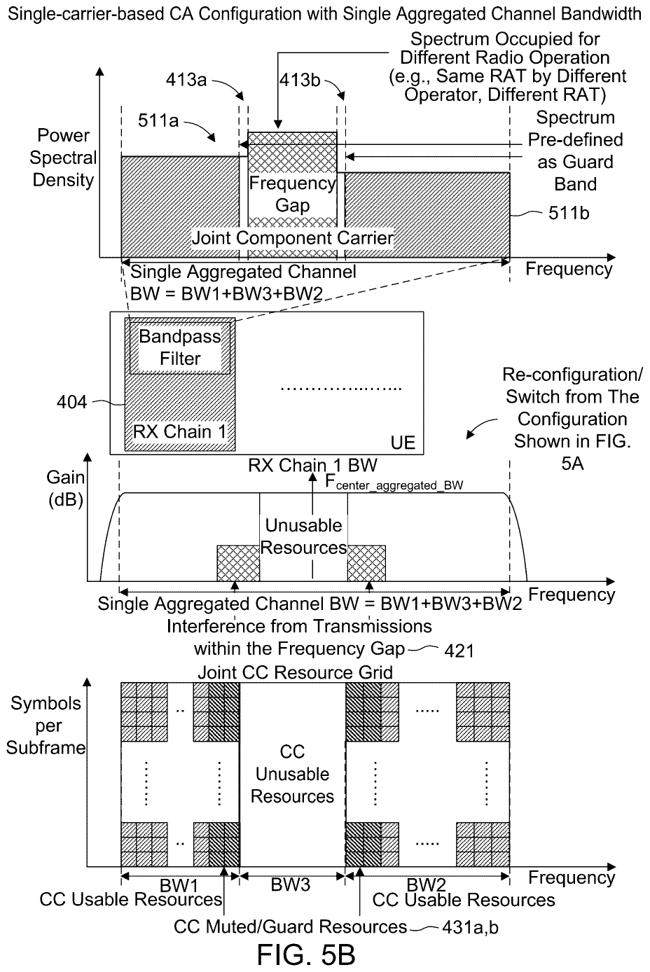

In another example, a WTRU may switch between a multi-carrier-based CA configuration with separate sub-block bandwidths and single-carrier-based CA configuration with single aggregated channel bandwidth as indicated in FIGS. 5A-5B.

Shown in FIG. 5A is an example of a multi-carrier based CA configuration with separated channel bandwidth 501. FIG. 5B illustrates an example of single-carrier based CA configuration with single aggregated channel bandwidth 502 for a joint component carrier implementation. As shown in FIGS. 5A and 5B, guard bands on either side of the frequency gap are pre-defined in the spectrum. Such guard bands may mitigate the need for muting of resources adjacent the frequency gap. As shown in FIG. 5B, there may be a joint component carrier on either side of the frequency gap. RX chain gain and usable resources are shown, respectively, in graphs 503 and 505 for FIG. 5A and in graphs 504 and 506 for FIG. 5B.

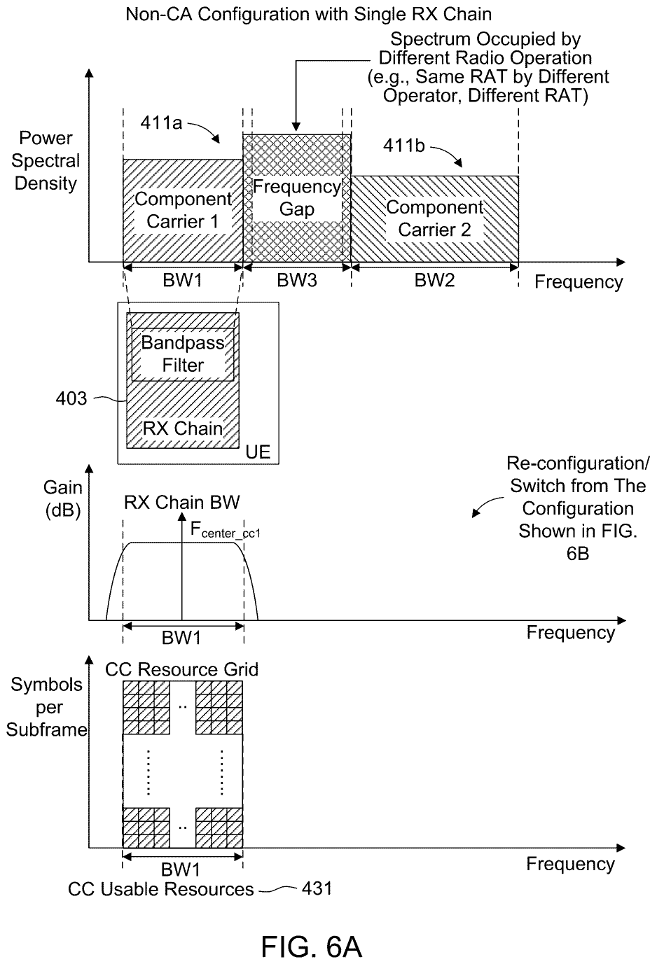

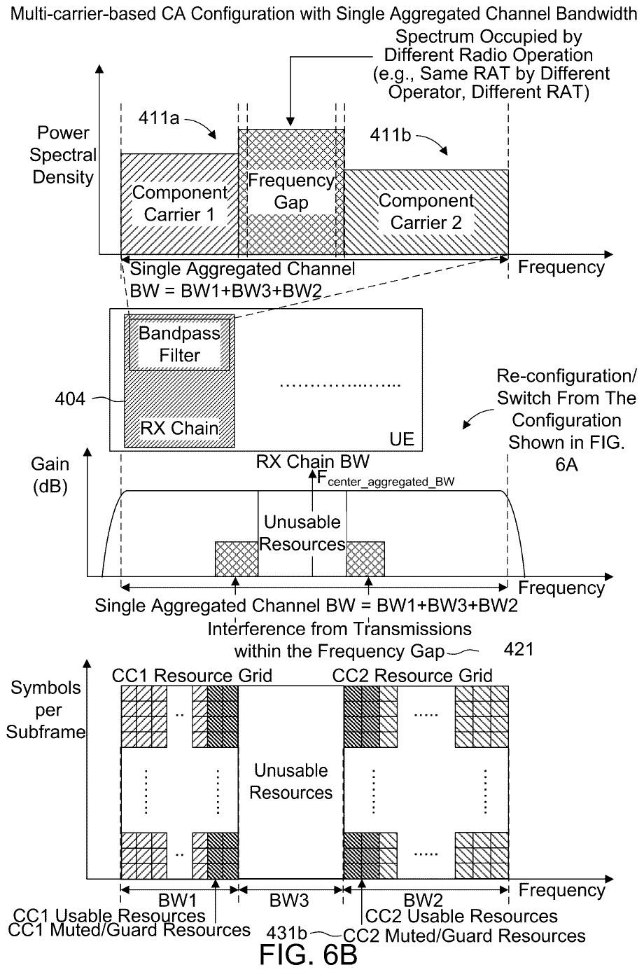

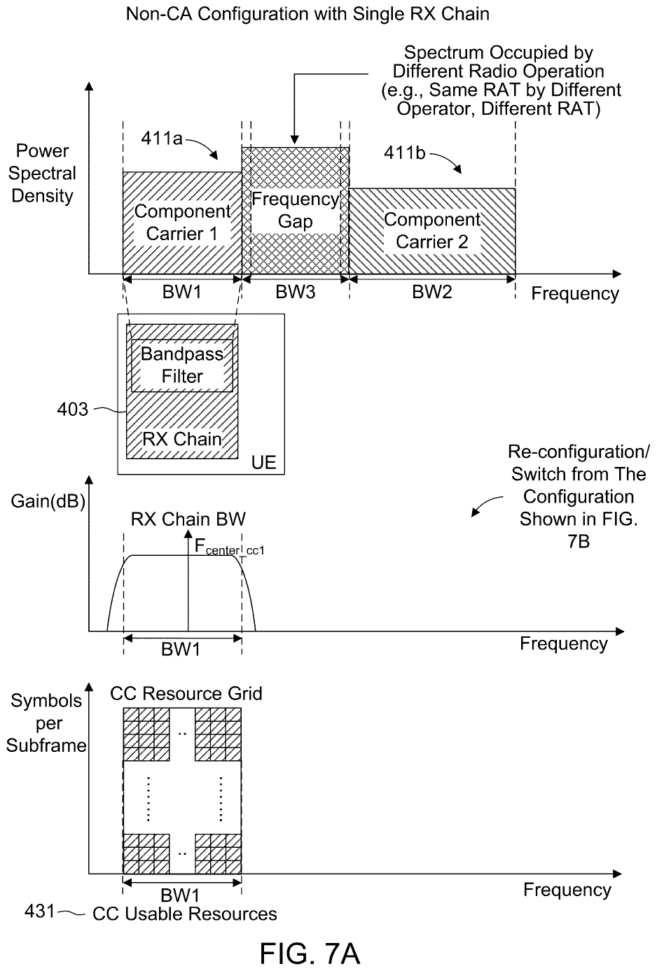

In another example, as shown in FIG. 6A, a WTRU may be (pre) configured with a non-CA configuration 601 with a single RX chain as the default/fallback configuration. In this example, a WTRU may initiate with non-CA configuration for operation without CA. A WTRU may switch may be made between the non-CA configuration and a multi-carrier-based CA configuration with a single aggregated channel bandwidth 602 that includes intra-band non-contiguous component carriers 411a, 411b and the frequency gap therebetween. RX chain gain and usable resources are shown, respectively, in graphs 603 and 605 for FIG. 6A and in graphs 604 and 606 for FIG. 6B.

FIG. 6B illustrates an example of a multi-carrier based CA configuration 602 with a single aggregated channel bandwidth, the signals of which may be received by RX chain 404

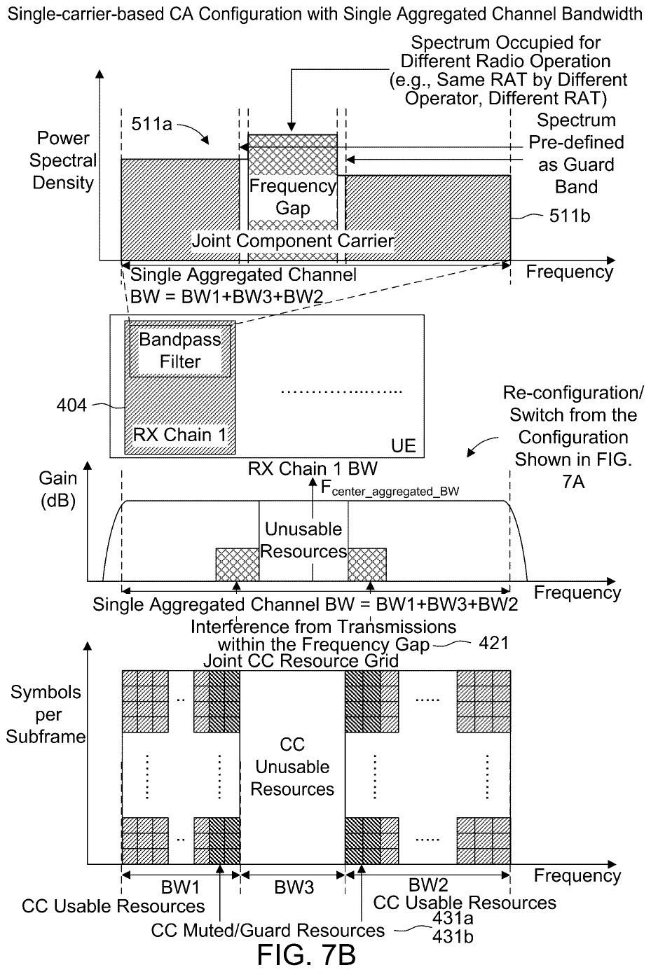

In another alternative, as shown in FIGS. 7A-7B, a WTRU may switch between a non-CA configuration 701 with a single RX chain 403, shown by way of example in FIG. 7A, and a single-carrier-based CA configuration 702 with single aggregated channel bandwidth for CA 704 including intra-band non-contiguous component carriers 511a, 511b, shown by way of example, in FIG. 7B.

FIG. 7B illustrates a joint component carrier with portions 511a, 511b on either side of the frequency gap. RX chain gain and usable resources are shown, respectively, in graphs 703 and 705 for FIG. 7A and in graphs 704 and 706 for FIG. 7B.

In certain representative embodiments, the wireless network may instruct or request (e.g., using RRS signaling or in a MAC CE or DCI transmission) the WTRU to switch between configurations. For example, the WTRU may receive an identity of the CA configuration to use, e.g. a CA configuration ID indicated by a codepoint of this information field. A WTRU may switch to the indicated CA configuration in response to receiving such an indication in MAC CE and/or DCI signaling.

By way of further example, the WTRU may be (pre) configured with a BWP configuration associated with each CA configuration. The WTRU may be instructed or requested to switch a BWP and, thereby, CA configuration accordingly. For example, the BWP (pre) configuration and association with CA configuration may be as follow: A WTRU may be (pre) configured with a single BWP associated with single-carrier-based CA configuration with single aggregated channel bandwidth; or the WTRU may be (pre) configured with multiple BWPs with one BWP per aggregated component carrier associated with multi-carrier-based CA configuration with separate sub-block bandwidth.

A WTRU may report measurement data to the wireless network 104 to assist in, or to trigger, the configuration switch. For example, a WTRU may report measurement results periodically and/or to perform an aperiodic measurement and reporting accordingly. The MAC CE and/or DCI signaling may include a measurement and reporting request, corresponding request measurement configuration and uplink resource for reporting transmission.

In certain representative embodiments, a WTRU may determine to report a (pre) configured event and/or condition associated with a CA configuration switch based on one or more single aggregated channel bandwidth measurements and/or real-time performance metrics.

In certain representative embodiments, a WTRU may report one or more of the following event(s) and/or condition(s) associated with a CA configuration switch from the default/fallback multi-carrier-based CA configuration with separate sub-block bandwidth to single- or multi-carrier-based CA configuration with single aggregated channel bandwidth. In another example, a WTRU may determine to report one or more of the following event(s) and/or condition(s) associated with a CA configuration switch from the default/fallback non-CA configuration to single- or multi-carrier-based CA configuration with single aggregated channel bandwidth.

The events and conditions may indicate that interference caused by the transmissions within the frequency gap within single aggregated channel bandwidth in general may not degrade the WTRU control and/or data performance, or may not degrade the WTRU control and/or data performance to an unacceptable level. Such parameters may include one or more of:

The measured and evaluated RSSI level of the frequency gap within the single aggregated channel bandwidth is below a threshold; the measured and evaluated RSSI level of the frequency gap within the single aggregated channel bandwidth is lower than the measured and evaluated RSSI level of each aggregated component carrier and/or a delta between the RSSI level of the frequency gap and that of any aggregated component carrier is above a threshold; the delta between the measured and evaluated RSSI level of any aggregated component carrier based on separate sub-block channel bandwidth or non-CA configuration and the same measurement results based on single aggregated channel bandwidth is below a threshold; the measured and evaluated RSRQ and/or L1-SINR of CSI-RS and/or SSB transmission in each aggregated component carrier is above a threshold; the delta between the measured and evaluated RSRQ and/or L1-SINR of CSI-RS transmission in each aggregated component carrier based on separate sub-block channel bandwidth or non-CA configuration and the same measurement results based on single aggregated channel bandwidth is below a threshold; the measured and evaluated interference level (i.e. IM) in CSI-RS resources in each aggregated component carrier is below a threshold; the delta between the measured and evaluated interference level (i.e. IM) in CSI-RS resources in each aggregated component carrier based on separate sub-block channel bandwidth or non-CA configuration and the same measurement results in CSI-RS resources based on single aggregated channel bandwidth is below a threshold; the delta between the measured and evaluated RSSI level of the frequency gap and the same measurement results of joint component carrier is above a threshold; the number of (pre) configured resources at the edge of the aggregated component carriers adjacent to the frequency gap of which the measured and evaluated CSI-IM and RSSI of the transmissions within the frequency gap is above a threshold is below a threshold; the number of (pre) configured resources at the edge of the aggregated component carriers adjacent to the frequency gap of which the measured and evaluated CSI/SS-RSRQ, CSI/SS-RSSI and/or CSI/SS-L1-SINR is below a threshold is below a threshold; the value of a counter for the occurrences of one or more such events and/or conditions exceeds a threshold.

One or more such events/conditions may indicate that the number of resources interfered by the transmissions from the frequency gap may be low.

A WTRU may be (pre) configured with different thresholds associated with a CA configuration switch from the default/fallback multi-carrier-based CA configuration with separate sub-block bandwidth to multi-carrier-based CA configuration with single aggregated channel bandwidth and single-carrier-based CA configuration with single aggregated channel bandwidth, respectively. In another example, the threshold may be associated with the reported WTRU capability discussed above. In another example, the (pre) configured threshold may be associated with Block Error Ratio (BLER) of a downlink control and/or data reference channel transmission. A control reference channel may e.g., carry a DCI format 1_0 with an Aggregation Level (AL) of 8 or 16. In a further example, the threshold may be associated with the size of the frequency gap. In another example, the (pre) configured threshold may be associated with the number of the (pre) configured resources, e.g. RBs/RBGs at the edge of aggregated component carrier for the measurement.

A WTRU may determine to report one or more of the following event(s) and/or condition(s) associated with a CA configuration switch from a multi-carrier-based CA configuration or single-carrier-based CA configuration with single aggregated channel bandwidth to the default/fallback multi-carrier-based CA configuration with separate sub-block bandwidth, i.e. a fallback switch. In another example, a WTRU may determine to report one or more of the following event(s) and/or condition(s) associated with a CA configuration switch from a single-or multi-carrier-based CA configuration with single aggregated channel bandwidth to a default/fallback non-CA configuration, i.e. WTRU may switch CA to a non-CA operation. The events and conditions may indicate that interference level caused by the transmissions within the frequency gap within single aggregated channel bandwidth may in general lead to WTRU control and/or data performance degradation: the measured and evaluated RSSI level of the frequency gap within the single aggregated channel bandwidth is above a threshold; the value of a counter for the occurrences of such events and/or conditions exceeds a threshold; the measured and evaluated RSSI level of the frequency gap within the single aggregated channel bandwidth is higher than the measured and evaluated RSSI level of one or more aggregated component carrier(s); the delta between the RSS level of the frequency gap and that of any aggregated component carrier is above a threshold; the delta between the measured and evaluated RSSI level of any aggregated component carrier based on separate sub-block channel bandwidth and that based on single aggregated channel bandwidth is above a threshold; the measured and evaluated RSRQ and/or L1-SINR of CSI-RS and/or SSB transmission in each aggregated component carrier is below a threshold; the measured and evaluated RSRQ and/or L1-SINR of CSI-RS transmission in any aggregated component carrier based on separate sub-block channel bandwidth or non-CA configuration is higher than the same measurement results of CSI-RS transmission based on single aggregated channel bandwidth by a delta above a threshold; the measured and evaluated interference level (i.e. IM) in CSI-RS resources in each aggregated component carrier is above a threshold; the measured and evaluated interference level (i.e. IM) in CSI-RS resources in each aggregated component carrier based on separate sub-block channel bandwidth or non-CA configuration is lower than the same measurement results in CSI-RS resources based on single aggregated channel bandwidth by a delta above a threshold; the delta between the measured and evaluated RSSI level of the frequency gap within the single aggregated channel bandwidth and the measured and evaluated RSSI level of joint component carrier is below a threshold; the number of (pre) configured resources at the edge of the aggregated component carriers adjacent to the frequency gap of which the measured and evaluated CSI-IM and RSSI of the transmissions within the frequency gap is above a threshold is above a threshold; the number of (pre) configured resources at the edge of the aggregated component carriers adjacent to the frequency gap of which the measured and evaluated CSI/SS-RSRQ, CSI/SS-RSSI and/or CSI/SS-L1-SINR is below a threshold is above a threshold; the value of a counter for the occurrences of one or more such events and/or conditions exceeds a threshold.

Such events/conditions, or a combination of more than one of them, may indicate the number of resources interfered by the transmissions from the frequency gap may be high.

A WTRU may be (pre) configured with thresholds associated with the fallback switch, i.e., from a single-carrier based or a multi-carrier-based CA configuration with single aggregated channel bandwidth to a multi-carrier-based CA configuration with separate sub-block channel bandwidth and/or from single- or multi-carrier-based CA configuration with single aggregated channel bandwidth to a non-CA configuration. In another example, the threshold may be associate with the reported WTRU capability. In another example, the (pre) configured threshold may be associated with Block Error Ratio (BLER) of a downlink control and/or data reference channel transmission. A control reference channel may e.g., carry a DCI format 1_0 with an Aggregation Level (AL) of 8 or 16. In a further example, the threshold may be associated with the size of the frequency gap. In another example, the (pre) configured threshold may be associated with the number of the (pre) configured resources, e.g. RBs/RBGs at the edge of aggregated component carrier for the measurement.

The number of out-of-sync indications and/or beam failure instance counts may exceed a threshold in Radio Link Monitoring (RLM) and/or Beam Failure Recovery (BFR) of any of the aggregated component carrier. A WTRU may be (pre) configured with a threshold with an offset below the maximum value to declare Radio Link Failure (RLF) and/or Beam Failure. The purpose may be enabling a WTRU to fall back to the default/fallback CA configuration before any of the failures may occur.

A WTRU may indicate the measurement spatial filter configuration for the reported events and/or conditions, e.g. an indication of TCI state and/or SSB index corresponding to the measurement spatial filter configuration. In one example, for CSI-RS and/or SSB measurement, the WTRU may apply a measurement spatial filter configuration as indicated in the TCI state associated with the CSI-RS and/or SSB transmission. For RSSI measurement, a WTRU may use a measurement spatial filter configuration identical to the one used to receive the SSB of the configured PCell, i.e. SSB transmission associated with the cell access information.

In a further solution, a WTRU may determine to transmit a CA configuration switch request in an UL transmission to the network when one or more of the forementioned event(s) and/or condition(s) may occur. The request transmission may indicate a CA configuration switch associated with the occurred events(s) and/or condition(s). For example, a WTRU may transmit a CA configuration switch request to switch from the default/fallback multi-carrier-based CA configuration with separate sub-block bandwidth to single- or multi-carrier-based CA configuration with single aggregated channel bandwidth when the one or more of associated event(s) and/or condition(s) may occur. In another example, a WTRU may transmit a CA configuration switch request to switch from a single- or multi-carrier-based CA configuration with single aggregated channel bandwidth to the default/fallback multi-carrier-based CA configuration with separate sub-block bandwidth, i.e. a fallback switch, when the one or more of associated event(s) and/or condition(s) may occur.

In a further example, a WTRU may transmit a CA configuration switch request to switch between a single- or multi-carrier-based CA configuration with single aggregated channel bandwidth to the default/fallback non-CA configuration when the one or more of associated event(s) and/or condition(s) may occur.

A WTRU may transmit a CA configuration switch request in a random access channel transmission, e.g. PRACH. A WTRU may be (pre) configured with one or more Contention Free Random Access (CFRA) PRACH preambles. In one example, a (pre) configured preamble may correspond to a CA configuration (e.g., CA configuration ID) and a WTRU may determine to use a preamble corresponding to the CA configuration to which the WTRU may request to switch. In another example, a (pre) configured preamble may correspond to a CA configuration switch, i.e., a combination of a CA configuration to switch from and another CA configuration to switch to. A WTRU may determine to the use a preamble corresponding to requested CA configuration switch. In another solution, a WTRU may transmit a CA configuration switch request in a UL control channel transmission, e.g., PUCCH. A WTRU may indicate the CA configuration ID using a codepoint in the PUCCH transmission. In another example, a codepoint in PUCCH may be (pre) configured to indicate a CA configuration switch as discussed above and a WTRU may set the codepoint according to the request CA configuration switch.

In certain representative embodiments, a WTRU may determine performance of a CA configuration switch associated with one or more event(s) and/or conditions(s) may occur. For example, a WTRU may determine to switch from the default/fallback multi-carrier-based CA configuration with separate sub-block bandwidth to a single- or multi-carrier-based CA configuration with single aggregated channel bandwidth when one or more associated event(s) and/or condition(s) may occur. The associated event(s) and/or condition(s) may be identical to those discussed above for WTRU determination to report the event(s) and/or condition(s) or perform a CA configuration request transmission for the same CA configuration switch.

In another example, a WTRU may determine to switch from a single- or multi-carrier-based CA configuration with single aggregated channel bandwidth to the default/fallback multi-carrier-based CA configuration with separate sub-block bandwidth, i.e. a fallback switch when one or more associated event(s) and/or condition(s) may occur. The associated event(s) and/or condition(s) may be identical to those discussed above for WTRU determination to report the event(s) and/or condition(s) or perform a CA configuration request transmission for the same CA configuration switch.

In a further example, a WTRU may determine to switch from a single- or multi-carrier-based CA configuration with single aggregated channel bandwidth to the default/fallback non-CA configuration when one or more associated event(s) and/or condition(s) may occur. The associated event(s) and/or condition(s) may be identical to those discussed above for WTRU determination to report the event(s) and/or condition(s) or perform a CA configuration request transmission for the same CA configuration switch.

In a further example, a WTRU may determine to switch from the default/fallback non-CA configuration to a single- or multi-carrier-based CA configuration with single aggregated channel bandwidth when one or more associated event(s) and/or condition(s) may occur. The associated event(s) and/or condition(s) may be identical to those discussed above for WTRU determination to report the event(s) and/or condition(s) or perform a CA configuration request transmission for the same CA configuration switch.

In a further solution, a WTRU may determine to switch between CA configurations based on information pertaining to the transmissions within the frequency gap. In one example, a WTRU may be indicated with transmission ON/OFF schedule information, e.g. including the timer periods in which the transmissions within the frequency gap may be turned off.

The RAT operating within the frequency gap in the single aggregated channel bandwidth may be 5G NR by another operator and the cell may be (pre) configured with a Network Energy Saving (NES) state in which the cell transmission may be turned on and off according to a TX ON/OFF schedule. A WTRU may determine to switch from the default/fallback multi-carrier-based CA configuration with separate component carriers (sometimes referred to in some implementations as sub-blocks) separately to multi-carrier-based CA configuration or single-carrier-based CA configuration with single aggregated channel bandwidth during the indicated transmission OFF period, e.g., when the NES cell operating within the frequency gap may be in a TX OFF state. A WTRU may determine to switch from a multi-carrier-based CA configuration or single-carrier-based CA configuration with single aggregated channel bandwidth to the default/fallback multi-carrier-based CA configuration with separate sub-block bandwidth, e.g., a fallback switch during the indicated transmission ON period, e.g., when the NES cell operating within the frequency gap may be in a TX ON state.

When a WTRU performs a configuration switch (e.g., as indicated by the network or determined by the WTRU), the WTRU may transmit a CA configuration switch indication to the network. The CA configuration switch indication transmission may indicate the CA configuration to which the WTRU switched or to which a switch may occur or should occur based on measured conditions and parameters. Also, a WTRU may indicate the measurement spatial filter configuration, e.g. using an indication of the corresponding TCI state and/or SSB index.

A WTRU may transmit a CA configuration switch indication in a random access channel transmission, e.g. PRACH. A WTRU may be (pre) configured with one or more Contention Free Random Access (CFRA) PRACH preambles. In one example, a (pre) configured preamble may correspond to a CA configuration (e.g., CA configuration ID) and a WTRU may determine to use a preamble corresponding to the CA configuration to which the WTRU may have switched to. In another example, a (pre) configured preamble may correspond to a CA configuration switch, i.e., a combination of a CA configuration to switch from and another CA configuration to switch to. A WTRU may determine to the use a preamble corresponding to requested CA configuration switch. Or, the WTRU may indicate the new CA configuration in a UL control channel transmission, e.g., PUCCH. A WTRU may indicate the CA configuration ID using a codepoint in the PUCCH transmission. In another example, a codepoint in PUCCH may be (pre) configured to indicate a CA configuration switch as discussed above and a WTRU may set the codepoint according to the performed CA configuration switch.

In certain representative embodiments, a WTRU may indicate a CA capability update after a CA configuration switch. In one example, when a WTRU switches from a multi-carrier CA configuration to a single-carrier CA configuration, a WTRU may indicate a decrease in the number of the used RX chain for carrier aggregation. In another example, when a WTRU switches from a single-carrier CA configuration to a multi-carrier CA configuration, a WTRU may indicate an increase in the number of used RX chain for carrier aggregation. In both examples, a WTRU may not update the number of aggregated component carriers.

In one solution, a WTRU may perform a RRC re-configuration e.g., for PCell and/or SCell after a CA configuration switch by switching to the RRC configuration(s) associated with the new CA configuration. For example, when switching between a multi-carrier CA configuration with separate sub-block channel bandwidth and a multi-carrier CA configuration with single aggregated channel bandwidth, a WTRU may apply the RRC configuration of each aggregated component carrier associated with the CA configuration. The RRC configuration of each aggregated component carrier associated with multiple-carrier CA configuration with separate sub-block channel bandwidth and single aggregated channel bandwidth may be identical. In another example, when switching from a multi-carrier-based CA configuration with separate sub-block channel bandwidth to a single-carrier CA configuration with single aggregated channel bandwidth, the WTRU may apply a RRC configuration associated with a joint component carrier. In a further example, when a WTRU switches from a non-CA configuration to a single- or multi-carrier-based CA configuration with single aggregated channel bandwidth, a WTRU may apply a RRC configuration associated with a joint component carrier.

A WTRU may perform a synchronization with SSB transmission of aggregated or joint component carrier according to the RRC configuration. For the single-carrier-based CA configuration, a WTRU may re-tune the center frequency to the one in the middle of the single aggregated channel bandwidth. A WTRU may not expect control and/or data scheduling during a (pre) configured re-tuning period when a WTRU may switch between a CA configuration with separate sub-block channel bandwidth and a CA configuration with single aggregated channel bandwidth.

For a multi-carrier-based CA configuration with single aggregated channel bandwidth, a WTRU may determine a common RB resource grid within each aggregated component carrier. A WTRU may be (pre) configured with a BWP including contiguous PRBs for each aggregated component carrier (as shown in FIGS. 4A-4B). There may not be any RBs in the frequency gap in the BWPs.

For a single-carrier-based CA configuration with single aggregated channel bandwidth, a WTRU may determine a common RB resource grid based on the channel bandwidth of the joint component carrier--a bandwidth that includes the channel bandwidth of each aggregated component carrier and the frequency gap in-between. A WTRU may be (pre) configured with a BWP including contiguous PRBs located within the frequency gap. A WTRU may determine a resource grid within the BWP corresponding to single-carrier-based CA configuration with single aggregated channel bandwidth. In one example, a WTRU may be (pre) configured with a number of unused resources in a frequency gap within a single aggregated channel bandwidth.

In certain representative embodiments, a WTRU may determine muted/guard resources (sometimes referred as muted resources) within a resource grid, for example, when a WTRU is using (or before the WTRU switches to) a CA configuration with single aggregated channel bandwidth. When a resource is determined as a muted/guard resources, the resources may not be used (hence muted) for transmission and/or reception. The muted resources may be considered a type of guard band resources to insulate most of the resources within the aggregated component carriers from interferences caused by the transmissions within the frequency gap. This may be related to the adjacent channel power leakage ratio (ACLR) performance of the RAT operating in the frequency gap.

A WTRU may update the resource grid by excluding the determined muted resources from the resource grid. For a multi-carrier-based CA configuration, a WTRU may determine muted resource in the BWP of each aggregated component carrier. For a single-carrier-based CA configuration, a WTRU may determine muted resources in the BWP of the joint component carrier.

In certain representative embodiments, a WTRU may be (pre) configured with a fixed number of guard resources when the WTRU may perform a CA based on a single-carrier or multi-carrier-based CA configuration with single aggregated channel bandwidth. For example, a WTRU may be indicated with a fixed number of muted/guard resources at the edge of each aggregated component carrier that may be adjacent to a frequency gap. In another example, a WTRU may be allocated with a set of muted/guard resource (pre) configurations associated with one or more the following parameters and a WTRU may select a (pre) configuration based on one or more associated parameters: size/Bandwidth of the frequency gap (e.g., MHz/Hz, number of RBs/sub-carriers); size/Bandwidth of the single aggregated channel bandwidth (e.g., MHz/Hz, number of RBs/sub-carriers); channel bandwidth of aggregated component carrier (e.g., MHz/Hz, number of RBs/sub-carriers); reported WTRU capability and/or capability metrics and conditions discussed in section 4.1.4.

In certain representative embodiments, determination of the fixed muted resources may thus be based on a worst scenario given the reported WTRU capability and the network information about the RAT and/or transmission parameters used in the frequency gap. Considering the factors including e.g., traffic load and NES operation, the required muted resources may become lower and the fixed allocation may lead to inefficient resource utilization.

According to an embodiment, a number of muted/guard candidate resources may be set and a WTRU may dynamically determine and update the extent of muted resources among the (pre) configured candidate resources based on one or more candidate muted resource measurement(s). The candidate muted resources may include resources, e.g., RBs and/or sub-carriers located at the edge of each aggregated component carrier that may be adjacent to the frequency gap. The number of (pre) configured candidate muted resources may be associated with the same parameters as listed above for fixed muted resource allocation. A WTRU may undertake one or more of the following candidate muted resource measurements: CSI-RSSI/RSRQ/L1-SINR and/pr SS-RSSI/RSRQ/L1-SINR measurement; RSRQ and/or SINR measurement on a CSI-RS and/or SSB transmission (pre) configured with the measurement bandwidth; RSSI and/or IM measurement; RSSI and/or IM measurement on the measurement bandwidth.

In certain representative embodiments, a WTRU may not expect control and/or data transmission scheduled within during the measurement. A WTRU may measure and evaluate the RSSI and/or interference from the transmissions within the frequency gap in these measurements.

In one example, a WTRU may be (pre) configured with one or more measurement bandwidths including one or more candidate muted resources. A WTRU may perform a candidate muted resource measurement using different measurement bandwidths. A WTRU may determine the candidate resources within a measurement bandwidth to be muted resources when one or more of the following conditions may occur: the measured CSI-RSSI/RSRQ/L1-SINR and/pr SS-RSSI/RSRQ/L1-SINR is below a threshold for muted resource determination; the measured RSSI and/or IM level is above a threshold for muted resource determination.

In an implementation, a WTRU may be (pre) configured with thresholds for muted resource determination and the threshold may be associated with each measurement and/or the measurement bandwidth used for the measurement. For example, the (pre) configured threshold may be associated with Block Error Ratio (BLER) of a downlink control and/or data reference channel transmission. A control reference channel may e.g., carry a DCI format 1_0 with an Aggregation Level (AL) of 8 or 16.

In another approach, a WTRU may be (pre) configured with additional threshold(s) for CA configuration switch. For example, a WTRU may determine to perform a fallback switch, i.e. a switch from a single- or multi-carrier CA configuration with single aggregated channel bandwidth to a default/fallback multi-carrier CA configuration with separate sub-block channel bandwidth when one or more of the following conditions may occur: the measured CSI-RSSI/RSRQ/L1-SINR and/pr SS-RSSI/RSRQ/L1-SINR for muted resource determination is below a threshold for CA configuration switch; the measured RSSI and/or IM level is above a threshold for CA configuration switch.

A WTRU may manage muted resources 431a, 431b periodically and determine when the number of out-of-sync indications and/or beam failure instance counts may exceed a threshold in Radio Link Monitoring (RLM) and/or Beam Failure Recovery (BFR) of the joint component carrier. A WTRU may be (pre) configured with a threshold with an offset below the maximum value to declare Radio Link Failure (RLF) and/or Beam Failure.

A WTRU may transmit a report of the determined muted resources 431a, 431b to the network. For example, the WTRU may include a bit map corresponding to the resource grid of the aggregated component carrier or the joint component carrier. A WTRU may indicate, e.g., set the value of the bit corresponding to a muted resource to one in the reported bit map.

A WTRU may update the resource grid of the aggregated component carrier or the joint component carrier according to the dynamically determined muted resources and unusable resources 421. For example, a WTRU may determine a resource grid including unusable resources 421 within a frequency gap and/or muted resources 431a, 431b within the channel bandwidth of aggregated component carrier as shown in FIGS. 4A, 4B for multi-carrier-based CA and FIG. 5B for single-carrier-based CA configuration. A WTRU may denote each resource, e.g., a resource element (RE), a RE group (REG), a sub-carrier, an RB, an RB group (RBG) with sequential index in the resource grid. Accordingly, a WTRU may identify a set of indices indicating the unusable and/or muted resources. A WTRU may also determine in which aggregated component carrier a resource may be located based on the indexing of the resource grid of a joint component carrier. By way of illustration, a WTRU may determine different sets of indices indicating resources located in different aggregated component carrier within the single bandwidth of a joint component carrier.

The frequency resource allocation indication in DCI format for PDSCH and/or PUSCH may indicate the start frequency resource, e.g., starting RB/RBG (RB group) and the number of allocated contiguous frequency resources, e.g. number of RBs/RBGs. In one solution, a WTRU may determine PDSCH scheduling information based on the unusable and/or muted resources within the frequency grid. For example, a WTRU may exclude the muted resources from scheduled PDSCH resources when a scheduled contiguous PDSCH resource allocation may include unusable and/or muted resources.

In certain representative embodiments, a WTRU may receive semi-statical scheduling information, e.g., configured grant (CG) for UL transmission and Semi-Persistent Scheduling (SPS) for DL transmission with common parameters between different CA configuration and parameters associated with CA configurations. Or, a WTRU may receive two sets of CG and/or SPS information and select the set associated with CA configuration based on the events and/or conditions discussion for CA configuration switch. For example, when a WTRU determines that events and/or conditions associated with a CA configuration call for a switch to a single- or multi-carrier-based CA configuration with single aggregated channel bandwidth, a WTRU may select corresponding CG and/or SPS parameters or an associated CG and/or SPS with exclusion of muted/guard resources and/or back-off of the maximum transmit power. In another example, when a WTRU determines that events and/or conditions associated with fallback switch to a multi-carrier-based CA configuration with separate sub-block channel bandwidth or non-CA configuration may occur, a WTRU may select corresponding CG and/or SPS parameters or an associated CG and/or SPS with all available resources in the resource grid and/or a (pre) configured maximum transmit power without back-off.

With a joint component carrier, i.e. single-carrier-based CA configuration with single aggregated bandwidth, shown as 511a, 511b in FIG. 7B, a WTRU may be (pre) configured with a BWP including frequency resources from two or more component carriers. The CA configuration may be WTRU-specific (as discussed, depending on WTRU measurements, conditions and/or capabilities). From a network perspective, each aggregated component carrier may be operated as a single carrier by the network. Accordingly, the power spectral density (PSD) of resources of each aggregated component carrier may be different, e.g. due to the antenna and radio hardware configuration. In addition, the traffic load may be different in each aggregated component carrier. The network may have real-time information of such imbalance in PSD and/or traffic load and thereby perform adaptation for WTRUs performing CA aggregation using single aggregated channel bandwidth. In one example, the network may re-configure PDCCH frequency resource allocation dynamically between resources within the bandwidth of different component carrier based on the transmit power and traffic load variation to optimize PDCCH capacity and performance.

In certain representative embodiments, a default PDCCH resource allocation, e.g., a CORESET 0, may be indicated to the WTRU. A CORESET may be a resource allocation, e.g., a combination of symbols and/or slots in the time domain and sub-carrier/PRBs in the frequency domain on the resource grid. A WTRU may be informed of time and frequency domain resource configuration for CORESET 0 in a cell broadcast transmission (e.g. PBCH) and/or RRC signaling. In one example, a WTRU may be indicated with CORESET 0 frequency resources within in bandwidth of the aggregate component carrier with the highest PSD. A WTRU may receive resource allocation information for additional CORESET(s), e.g., WTRU-specific CORESET(s). For example, a WTRU may receive a PDCCH within CORESET 0 that may carry a DCI format including CORESET allocation information. A WTRU may apply a (pre) configured RNTI the DCI format (pre) configured for CORESET allocation. A WTRU may receive the PDCCH using a (pre) configured aggregation level and PDCCH candidate position within CORESET 0 so that a WTRU may not perform a blind detection to receive the CORESET allocation DCI format. In another example, a WTRU may receive CORESET allocation information in a MAC CE carried in PDCCH scheduled by a PDCCH received in CORESET 0.

A WTRU may be (pre) configure with the CORESET allocation information included in a DCI format and/or MAC CE. In one example, the CORESET allocation information may be based on a bit map with each bit indicating a resource allocation (e.g., a sub-carrier, RB, RBG, RE, REG) in a resource grid. A WTRU may determine a resource may be assigned to a CORESET when the corresponding (pre) configured codepoint value may be indicated for the bit. In another example, a WTRU may be indicated with a starting resource and the number of resources. The starting resource may be an index of the resource in the resource grid. In a further example, a WTRU may be indicated with a (pre) configured CORESET resource allocation. In this example, a (pre) configured CORESET may be activated by an information field in a DCI format and/or MAC CE.

A WTRU may be (pre) configured with a set of increasing aggregation levels, e.g., 1, 2, 4, 8, 16. By way of example, a WTRU may determine an aggregation level associated with indicated CORESET based on which aggregated component carrier the indicated CORESET resource may be located in. A WTRU may determine in which aggregated component carrier the indicated CORESET may be located based on the index of the resources of the CORESET. In one example, a WTRU may be (pre) configured with an aggregation level (e.g., 8) for a CORESET (e.g. COREST 0) within frequency resources of an aggregated component carrier. The network may (pre) configured this CORESET in an aggregated component carrier with highest transmit power and/or PSD. A WTRU may determine to use the next higher aggregation level (e.g., 16) when the indicated CORESET may be in a different aggregate component carrier. This is to compensate the transmit power and/or PSD imbalance between the aggregated component carriers.

An example of a set of actions according to an implementation of an aspect of the disclosure is provided below. The WTRU determine that a switch of non-contiguous CA configurations based on measurements of the frequency gap.

A WTRU may be pre-configured with two carrier aggregation configurations for two intra-band non-contiguous component carriers. The first configuration may be based on a non-contiguous aggregated bandwidth combination including the channel bandwidth of each component carriers CC1, CC2 (designated in FIGS. 4A and 4B as 411a, 411b). Thus, the center frequency, channel bandwidth, and guard band, may be determined for each component carrier separately (as shown, for example, in FIG. 4A). This may be the default/fallback configuration for the device.

The second configuration may be based on a single aggregated channel bandwidth combination that includes the channel bandwidth of each component carrier CC1, CC2 (411a, 411b) and the frequency gap (CC gap) in-between the two component carriers (as shown, for example, in FIG. 4B). The center frequency and size of the aggregated bandwidth may thus be determined for this aggregated bandwidth. This may be a configuration in which frequency gap interference is measured.

For example, the WTRU is indicated to aggregate two intra-band non-contiguous component carriers according to the first CA configuration. However, the WTRU may perform one or more measurements according to the measurement configuration for single aggregated channel bandwidth of the second CA configuration. The WTRU may receive network indication based on RRC signaling (periodical/semi-static measurement), MAC CE/DCI (dynamic measurement). The CA may use one or more measurements, including, for example, RSSI of the frequency gap bandwidth, RSSI of single aggregated channel bandwidth, RSSI of the aggregated CCs, RSSI/RSRQ/L1-SINR/IM of RS transmissions within aggregated CCs, RSSI/RSRQ/L1-SINR/IM of (pre) configured resources at the edge of aggregated CCs. The RX beam for RSSI measurement may be based on SSB of an aggregated CC, e.g., PCell. Measurement processing (e.g., filtering/averaging/counting) and adjustment may be based on NW-indicated information regarding transmission within the component carrier gap (e.g., NES cell state/duty cycle).

Based on such data, the WTRU may report to the wireless network an event/condition associated with a CA re-configuration switch, for example, in response to determining that conditions are satisfactory for the second configuration. For example, the WTRU may determine one or more of the following: RSSI of the frequency gap is below a threshold, RSSI of CC1 and/or CC2 is higher than RSSI of the frequency gap by a delta above a threshold, RSSI/RSRQ/L1-SINR is above a threshold, IM is below a pre-configured threshold, a value of a counter is about the level above/below a threshold, a number of resources e.g., RBs/RBGs adjacent to the frequency gap (i.e. at the edge of the CC1 or CC2) of which the measured RSSQ/L1-SINR is below a threshold or RSSI/IM is above a threshold, and/or the WTRU may determine a threshold associated with WTRU capability (e.g., adjacent channel selectivity), parameters of supported bandwidth combination class (e.g., size of frequency gap), the preconfigured number of RBs at the edge of the CC1 and/or CC2.

Based on such a determination, the WTRU may transmit the determined information to the wireless network and/or may request to be switched to, or to remain in, the second configuration.

Using such a method may enable a WTRU to switch to a non-contiguous CA configuration using a single RX chain when transmissions in the frequency gap do not have major adverse impact on the WTRU reception of control/data within aggregated CCs. This may allow an operator to aggregate more CCs given a WTRU's CA capability with respect to the number of its RX chains and, for this reason, may achieve more efficient utilization of a fragmented spectrum in a cell. In response to an increase in interference (e.g., from the frequency gap), a WTRU may switch (back), or may be instructed by the wireless network to switch (back), to a default/fallback non-contiguous CA configuration using a single RX chain for each aggregated CC to prevent beam failure or radio link failure from occurring.

As discussed with regard to FIGS. 5A and 5B, according to another implementation of an aspect of the disclosure, the WTRU may dynamically determine muted/guard resources to exclude in resource allocation in a non-contiguous single aggregated channel bandwidth. The WTRU may be configured or pre-configured with two carrier aggregation configurations for two intra-band non-contiguous component carriers:

The first configuration may be based on a non-contiguous aggregated bandwidth combination that includes a channel bandwidth for a first carrier CC1 (411a) and a channel bandwidth for the second carrier CC2 (411b). In this first configuration, center frequencies, channel bandwidths, guard band may be determined for each CC separately. In certain representative embodiments, this may be a default/fallback configuration.

The second configuration may be based on a single aggregated channel bandwidth combination that include the channel bandwidth of both component carriers (CC1 and CC2) and the frequency gap (CC gap) in-between CC1 and CC2. The center frequency and size of the aggregated bandwidth, and the number of RBs may be determined for the single channel bandwidth combination. In this configuration, measurements may be made to determine whether to mute resources, e.g., a set of candidate muted RBs in CC1 and CC2 adjacent to the frequency gap.

The WTRU may determine, or the wireless network may request the WTRU, to re-configure/switch from the first CA configuration to the second CA configuration. For example, radio resource control (RRC) signaling may be used to report/request such re-configuration/Dynamic MAC (medium access control) CE/DCI (channel element/downlink control indicator) signaling.

The WTRU may determine muted/guard resources in the candidate resource set based on such factors as measured reference signal received quality RSRQ and/or L1-SINR (signal to interference-plus noise ratio) of the candidate muting resource, e.g. resources with measurement below a threshold; measured intermodulation (IM) of the candidate muting resource, e.g. resources with measurement above a threshold; received signal strength indicator (RSSI) measurement of the configured component carrier gap—for example, a pre-configured mapping between measured RSSI and resources to be muted, other such factors, or a combination of two or more of the foregoing.

The WTRU may transmit a report to the wireless network (e.g., the nearest base station) indicating the determined muted resource. For example, using a bit map with each bit corresponding to a PRB in the resource block grid, the resources to be muted may be communicated.

The WTRU may determine a usable resource block grid 433a, 433b that excludes RBs in the configured component carrier gap that are unusable/unreliably received and thus to be not included and therefore muted. The WTRU may exclude the determined and reported muted resources from received physical downlink shared channel (PDSCH) and/or physical uplink shared channel (PUSCH) frequency resource allocation. In certain representative embodiments, the wireless network may instruct the WTRU regarding what resources to mute based on signal reception/interference measurements made by the WTRU and reported to the wireless network. In certain representative embodiments, the wireless network may instruct the WTRU regarding what resources to mute based on signal reception/interference measurements made by the wireless network in communication with the WTRU. Such measurements may be taken periodically, or from time to time, such as upon detection of signal quality deterioration, and the extent of resources muted may be adjusted/re-adjusted in real time, accordingly.

According to an aspect of the disclosure, such a method may enable a WTRU to dynamically determine which resources should be muted (as guard band between the unwanted transmission in the frequency gap component and the wanted transmission in the aggregated component carriers adjacent the frequency gap) and not used. Since the received level of the unwanted transmission may vary in real time due to WTRU mobility and/or in response to transmission being ON/OFF of the RAT operating the spectrum, the number of muting/unusable resources required to minimize the interference may vary accordingly. Thus, a dynamic adjustment may provide efficient spectrum utilization. In another implementation, a fixed amount of guard band resources based on the worst-case scenario may be used, for example, for mission critical applications.

While configurations are sometimes described as receiving signals on two component carriers separated by a frequency gap, configurations that receive signals on more than two component carriers separated by two or more frequency gaps are also contemplated. Also, while sometimes communications between the WTRU and the wireless network is sometimes described with reference to the WTRU receiving communications via the component carriers, it will be understood that the WTRU may also transmit to the wireless network via one or more component carriers or resources thereof.

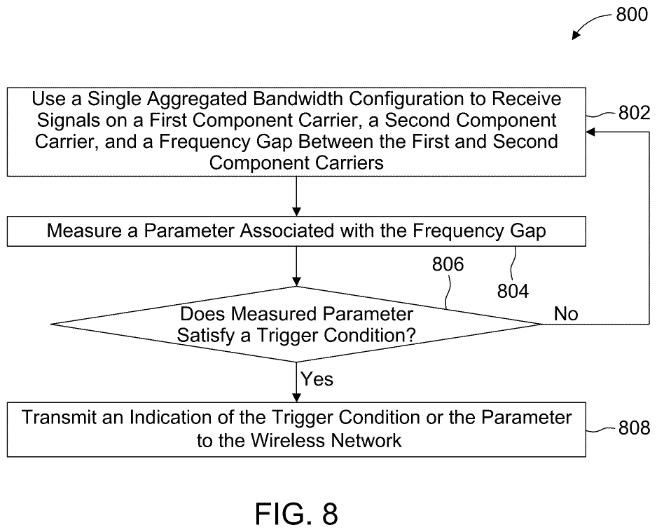

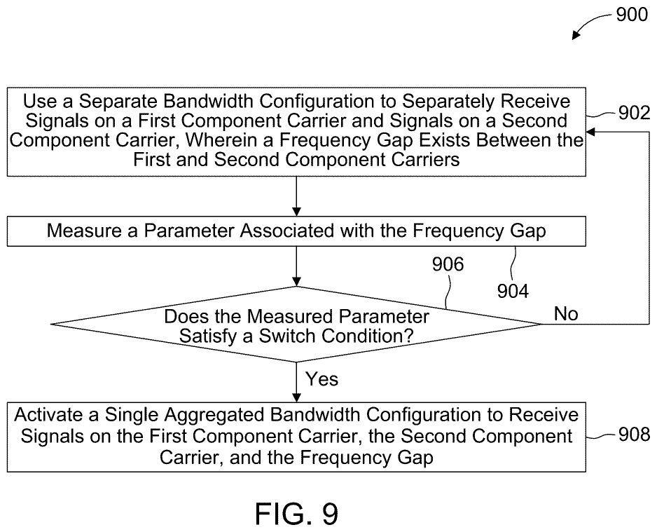

FIG. 8 is a process 800 performed by a WTRU (e.g., WTRU 102 of FIGS. 1A-D) in connection with a wireless network (e.g., RAN 104 and 113 of FIGS. 1A-D), which may be implemented in a communication system such as a communications system 100 illustrated in FIG. 1A-1D.

At 802, a WTRU, may use a single aggregated bandwidth configuration to receive signals on a first component carrier, a second component carrier, and a frequency gap between the first and second component carriers. An example of such a configuration is shown in FIG. 4B, 5B, 6B and 7B.

At 804, the WTRU may measure a parameter associated with the frequency gap. The parameter(s) measured may be related to frequency gap transmission strength and/or frequency gap transmission strength relative to component carrier transmission strength, or one or more of the parameters and conditions disclosed above. Also, one or more such measurements, or some of the data needed for such measurements, may be received from the wireless network.

At 806, the WRTU may determine whether a trigger condition is satisfied by the measured parameter. One or more such parameters, or a series or averaged values of series of one or more such parameters, may be used to determine whether the trigger condition is met. In certain representative embodiments, the wireless network may make the determination as to whether the trigger condition is met and inform the WTRU.

If the trigger condition is satisfied (“yes”) then, at 808, the WRTU may transmit an indication of the trigger condition and/or an indication of the parameter(s) to the wireless network.

The indication to the wireless network may communicate one or more of the parameter(s) measured, or one or more of the parameters used to make the trigger condition determination, or the indication to the wireless may be a flag to indicate that the parameter meets, or fails to meet, one or more parameter threshold and/or meets, or fails to meet, the trigger condition. In certain representative embodiments, the WRTU may transmit an indication of a failure to determine the trigger condition and/or an indication of the parameter(s) used to make the determination to the wireless network.

Based on such a trigger condition, the WRTU may take, or may be instructed by the wireless network to take, one or more of the actions (e.g., switching to a different CA configuration, maintaining the same CA configuration, and/or muting/unmuting some portion of CC resources, etc.) described herein.

FIG. 9 is a process 900 performed by a WTRU (e.g., WTRU 102 of FIGS. 1A-D) in connection with a wireless network (e.g., RAN 104 and 113 of FIGS. 1A-D), which may be implemented in a communication system such as a communications system 100 illustrated in FIG. 1A-1D.

At 902, a WRTU may use a separate bandwidth configuration to receive signals on a channel bandwidth of a first component carrier separately from a second component carrier. Examples of such configurations are shown in FIGS. 4A, 5A, 6A and 7A. A frequency gap may exist between the first and second component carriers.

At 904, the WRTU may measure a parameter associated with the frequency gap. Such parameters may be related to indications of frequency gap transmission strength, frequency gap transmission strength relative to component carrier transmission strength, or one or more of the parameters and conditions suggested above. One or more such measurements, or some of the data needed for such measurements, may be received from the wireless network.

At 906, the WRTU may determine whether the measured parameter satisfies a switch condition. One or more such parameters, or a series or averaged values of series of one or more such parameters, may be used to determine whether the switch condition is met. In certain representative embodiments, the wireless network may make the determination as to whether the switch condition is met.

If the switch condition is determined to be satisfied (“yes”), then at 908, a single aggregated bandwidth configuration may be selected and activated to receive signals on the first component carrier, the second component carrier, and the frequency gap. In certain representative embodiments, the WRTU may transmit an indication of a failure to determine the switch condition and/or an indication of the parameter(s) used to make the determination to the wireless network.

In certain representative embodiments, additional operations may be performed, such as determining a range of muted resources adjacent the frequency gap, as appropriate based on the conditions and parameters discussed above. The WTRU may continue to monitor one or more of the parameters and update the extent of muted resources based on real time conditions. In certain representative embodiments, the WRTU may be using a configuration other than the single aggregated bandwidth configuration when receiving such transmission and/or when performing such measurements.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

Itis also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “WTRU”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

What is claimed is:

1. A method performed by a wireless transmit/receive unit (WTRU) in communication with a wireless network, the method comprising:
using a single aggregated bandwidth configuration to receive signals on a first component carrier, a second component carrier, and a frequency gap between the first and second component carriers;
measuring a parameter associated with the frequency gap; and
based on the measured parameter satisfying a trigger condition, transmitting an indication of the trigger condition or the parameter to the wireless network.

2. The method of claim 1, further comprising:
based on the measured parameter satisfying the trigger condition, activating a separate bandwidth configuration to separately receive signals on the first component carrier and signals on the second component carrier.

3. The method of claim 1, further comprising:
after the transmitting the indication of the trigger condition or the parameter to the wireless network, receiving a request from the wireless network to use a separate bandwidth configuration to separately receive signals on the first component carrier and signals on the second component carrier.

4. The method of claim 1, further comprising:
determining muted resources in a resource set of the first and second component carriers based on the parameter; and
transmitting an indication of the determined muted resources to the wireless network.

5. The method of claim 4, wherein:
the parameter comprises a signal strength indicator of the frequency gap; and
the determined muted resources are determined based on a mapping between signal strength indicators and resources to be muted.

6. The method of claim 4, further comprising:
updating a resource grid of the first and second component carriers based on the determined muted resources.

7. The method of claim 1, further comprising:
before using the single aggregated bandwidth configuration, using a separate bandwidth configuration to separately receive signals on the first component carrier and signals on the second component carrier.

8. The method of claim 7, further comprising:
while using the separate bandwidth configuration, performing one or more measurements of the frequency gap to determine whether to switch to the single aggregated bandwidth configuration.

9. The method of claim 1, wherein the trigger condition is based on a signal strength indicator of the frequency gap.

10. The method of claim 1, wherein the trigger condition is based on a relationship between a signal strength of the frequency gap and the signal strength of at least one of the first component carrier or the second component carrier.

11. The method of claim 1, wherein the first component carrier and the second component carrier form a joint component carrier.

12. A wireless transmit/receive unit (WRTU) comprising:
a processor; and
a transceiver, wherein the WRTU is configured to:
receive, using a single aggregated bandwidth configuration, signals on a first component carrier, a second component carrier, and a frequency gap between the first and second component carriers;
measure a parameter associated with the frequency gap; and
based on the measured parameter satisfying a trigger condition, transmit an indication of the trigger condition or the parameter to the wireless network.

13. The WRTU of claim 12, wherein the WRTU is configured to:
based on the measured parameter satisfying the trigger condition, activate a separate bandwidth configuration to separately receive signals on the first component carrier and signals on the second component carrier.

14. The WRTU of claim 12, wherein the WRTU is configured to:
after the transmitting the indication of the trigger condition or the parameter to the wireless network, receive a request from the wireless network to use a separate bandwidth configuration to separately receive signals on the first component carrier and signals on the second component carrier.

15. The WRTU of claim 12, wherein the WRTU is configured to:
determine muted resources in a resource set of the first and second component carriers based on the parameter; and
transmit an indication of the determined muted resources to the wireless network, wherein the parameter comprises a signal strength indicator of the frequency gap, and the determined muted resources are determined based on a mapping between signal strength indicators and resources to be muted.

16. The WRTU of claim 12, wherein the WRTU is configured to:
before using the single aggregated bandwidth configuration, use a separate bandwidth configuration to separately receive signals on the first component carrier and signals on the second component carrier.

17. The WRTU of claim 16, wherein the WRTU is configured to:
while using the separate bandwidth configuration, perform one or more measurements of the frequency gap to determine whether to switch to the single aggregated bandwidth configuration.

18. The WRTU of claim 12, wherein the trigger condition is based on a signal strength indicator of the frequency gap.

19. The WRTU of claim 12, wherein the trigger condition is based on a relationship between a signal strength of the frequency gap and the signal strength of at least one of the first component carrier or the second component carrier.

20. A method performed by a wireless transmit/receive unit (WTRU) in communication with a wireless network, the method comprising:
using a separate bandwidth configuration to separately receive signals on a first component carrier and signals on a second component carrier, wherein a frequency gap exists between the first and second component carriers;
measuring a parameter associated with the frequency gap; and
based on the measured parameter satisfying a switch condition, activating a single aggregated bandwidth configuration to receive signals on the first component carrier, the second component carrier, and the frequency gap.
